(19) United States
(12) Patent Application Publication
(10) Pub. No.: US 2020/0265484 A1
(43) Pub. Date: Aug. 20, 2020

(54) SYSTEM AND METHOD FOR A MULTI-CHANNEL APPLICATION (APP) AND PLATFORM

(71) Applicant: NCX, INC., Richmond Hill (CA)

(72) Inventors: Nicole Caggiano, Toronto (CA); Nick Caggiano, Richmond Hill (CA)

(21) Appl. No.: 16/280,612

(22) Filed: Feb. 20, 2019

(51) Int. Cl. G06Q 30/02; G06Q 30/06; H04L 12/58; G06Q 50/00; G06Q 10/02

(52) U.S. Cl. CPC G06Q 30/0281; G06Q 30/0643; G06Q 30/0226; G06Q 50/01; G06Q 10/02; H04L 51/10

(57) ABSTRACT

In one embodiment, a mobile communication device configured with an application program for providing a user with a plurality of channels for interacting with a business enterprise comprising, a device display configured for displaying a plurality of screens generated by a processor executing the application program; each of the plurality of screens comprising one or more user responsive inputs; each of the plurality of channels comprising one or more of the plurality of screens, and the one or more user responsive input comprising context dependent functions for the associated channel; the plurality of channels comprising one or more of a service booking module, an ecommerce and payment module, a loyalty program module, an in-app consultation module, a client interaction module, a social media module and a marketing module.

### FIELD OF THE INVENTION

The present invention relates to computer systems and more particularly, to a system and method for a building a multi-channel customer application or app, an associated business application or app, and a platform configured for hosting, supporting and/or servicing the multi-channel application and/or the business application.

### BACKGROUND OF THE INVENTION

In the art, applications, commonly known as “apps” are well known. Apps are typically downloaded from an online service, such as the Apple “app store” and installed on a smart phone, e.g. the iPhone, or other smart device. Such known apps are typically limited to a single function.

It has been found that there is a need for apps that are built, branded and/or customized for a particular business or enterprise, and a platform that provides the capability to generate, host, maintain and/or support for a plurality of such apps or enterprises.

Accordingly, there remains a need for improvements in the art.

### BRIEF SUMMARY OF THE INVENTION

The present invention is directed to a system and a method for building an application (i.e. an “app” or “App”) comprising an omni- or multi-channel application, an associated business application or app, and a platform and a business or enterprise application configured for generating, hosting, supporting and/or servicing the multi-channel application.

According to an embodiment, the present invention comprises a mobile communication device configured for executing an application program for providing a user with a plurality of channels for interacting with a business enterprise, said mobile communication device comprising: a device display configured for displaying a plurality of screens generated by a processor executing the application program; each of the plurality of screens comprising one or more user responsive inputs; each of the plurality of channels comprising one or more of the plurality of screens, and the one or more user responsive input comprising context dependent functions for the associated channel; and the plurality of channels comprising one or more of a service booking module, an ecommerce and payment module, a loyalty program module, an in-app consultation module, a client interaction module, a social media module and a marketing module.

According to another embodiment, the present invention comprises computer system for generating and configuring a customer application (app) associated with a business enterprise, the system comprising: an end-user interface module, the end-user interface module being configured for providing access over the web for end-users comprising one or more consumer end-users and one or more business enterprise end-users; a services module, the services module being configured for generating and configuring the app; the services module being configured for generating a plurality of channels for the customer app for interacting with the business enterprise, and the plurality of channels comprising one or more of a service booking component, an ecommerce and payment module, a loyalty program module, an in-app consultation module, a client interaction module, a social media module and a marketing module; a database module, the database module being configured for storing data associated with the customer app and the business enterprise.

According to another embodiment, the present invention comprises computer program product comprising an application program for providing a user with a plurality of channels for interacting with a business enterprise, said computer program product being stored on a tangible machine readable medium, and comprising computer readable instructions for: generating a plurality of screens for display on a device; generating one or more user responsive inputs for each of the a plurality of screens; each of the plurality of channels comprising one or more of the plurality of screens, and said one or more user responsive inputs comprising context dependent functions for said associated channel; the plurality of channels comprising one or more of a service booking function, an ecommerce and payment function, a loyalty program function, an in-app consultation function, a client interaction function, a social media function and a marketing function.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 shows in diagrammatic form an exemplary network-based configuration suitable for implementing a system and a method according to embodiments of the present invention;

FIG. 2 shows in block diagram form an exemplary configuration for a client device or appliance or for a server of FIG. 1 suitable for implementing a system and/or processes according to embodiments of the present invention;

FIG. 3 shows in a block diagram form an exemplary high-level architectural configuration for the system and method according to an embodiment of the present invention;

FIG. 4 shows in block diagram form a system architecture for the system and method according to an embodiment of the present invention;

FIG. 5A shows in flowchart form an appointment booking function or process implemented for the system of FIG. 3 according to an embodiment of the present invention;

FIG. 5B shows in flowchart form an appointment booking function or process implemented at the administration level according to an embodiment of the present invention;

FIG. 6 shows in flowchart form a digital consultation function or process implemented for the system of FIG. 3 according to an embodiment of the present invention;

FIG. 7 shows in flowchart form a customizable services function or process implemented for the system of FIG. 3 according to an embodiment of the present invention;

FIG. 8A shows in flowchart form a refill/follow-up/recurring smart tracking function or process implemented for the system of FIG. 3 according to an embodiment of the present invention;

FIG. 8B shows in flowchart form a loyalty and discounts function or process for the system of FIG. 3 according to an embodiment of the present invention;

FIG. 8C shows in flowchart form a social media channel process for the system of FIG. 3 according to an embodiment of the present invention;

FIG. 8D shows in flowchart form an eCommerce and payments function or process for the system of FIG. 3 according to an embodiment of the present invention;

FIG. 8E shows in flowchart form a chat and push function or process for the system of FIG. 3 according to an embodiment of the present invention;

FIG. 9A is a screenshot of a Country, Location(s), Staff and Custom Forms selection page according to an embodiment of the present invention;

FIG. 9B is a screenshot of a Subscription Selection page according to an embodiment of the present invention;

FIG. 9C is a screenshot of a Business Information Setup page according to an embodiment of the present invention;

FIG. 9D is a screenshot of a Confirmation page according to an embodiment of the present invention;

FIG. 10A is a screenshot of a Customization Landing page according to an embodiment of the present invention;

FIG. 10B shows a graphical representation of an App generated for an iPhone according to an embodiment of the present invention;

FIG. 10C shows a Portal Side Menu page according to an embodiment of the present invention;

FIG. 10D shows a Progress Bar for creating an App according to an embodiment of the present invention;

FIG. 11A is a screenshot of a Create a Service page according to an embodiment of the present invention;

FIG. 11B shows a Service Details setup page according to an embodiment of the present invention;

FIG. 11C is a screenshot of a Consultation configuration page according to an embodiment of the present invention;

FIG. 12 is a screenshot of an Add Aftercare page or popup according to an embodiment of the present invention;

FIG. 13 is a screenshot of an In-App Consultation setup page according to an embodiment of the present invention;

FIG. 14A is a screenshot of a Setup Customers page according to an embodiment of the present invention;

FIG. 14B is a screenshot of an Add New Customer popup window according to an embodiment of the present invention;

FIG. 14C is a screenshot of an Import from CSV File popup window according to an embodiment of the present invention;

FIG. 15A is a screenshot of a Book Consultation popup window according to an embodiment of the present invention;

FIG. 15B is a screenshot of a Choose Location popup window for a consultation according to an embodiment of the present invention;

FIG. 15C is a screenshot of a Book Appointment Wizard according to an embodiment of the present invention;

FIG. 15D is a screenshot of an In-App Consultation page according to an embodiment of the present invention;

FIG. 15E is a screenshot of a Client In-App Consultation Status bar or screen showing a “Pending” status for the in-app consultation request;

FIG. 15F is a screenshot of a Client In-App Consultation Status bar or screen showing an “Approved” status for the in-app consultation request;

FIG. 15G is a screenshot of a Review page according to an embodiment of the present invention;

FIG. 15H is a screenshot of a screenshot of a Client In-App Consultation Status bar or screen showing an “Edited” status for the in-app consultation request;

FIG. 15I is a screenshot of a screenshot of a Client In-App Consultation Status bar or screen showing a “Not Approved” status for the in-app consultation request;

FIG. 16A shows screenshots of a booking wizard according to an embodiment of the present invention;

FIG. 16B shows screenshots of application pages in the customer App configured for accessing the associated booking wizard of FIG. 16A;

FIG. 17 shows a screenshot sequence for booking an appointment or service from a Categories page in the customer App;

FIG. 18 shows a screenshot sequence for booking an appointment or service from a Services page in the customer App;

FIG. 19 shows a screenshot sequence for booking an appointment or service from a Book from Services Details page in the customer App;

FIG. 20 shows a screenshot sequence for booking an appointment or service from a My Favourites List page in the customer App;

FIG. 21 shows a screenshot sequence for booking an appointment or service from a Package Details screen or page in the customer App;

FIG. 22A shows a screenshot sequence for booking a service or appointment which requires an “In-Store Consult” (consultation);

FIG. 22B shows a screenshot sequence for booking a service or appointment which requires an “In-App Consult” (consultation);

FIG. 22C shows a screenshot sequence for booking a service or appointment where an “In-Store Consult” or an “In-App Consult” are both available;

FIG. 23A shows in flowchart form a purchase package function or process for the system of FIG. 3 according to an embodiment of the present invention;

FIG. 23B shows in flowchart form a book a class function or process for the system of FIG. 3 according to an embodiment of the present invention;

FIG. 23C shows in flowchart form a customer forms function or process for the system of FIG. 3 according to an embodiment of the present invention;

FIG. 24 shows a screenshot sequence for a purchase product function or process for the system of FIG. 3 according to an embodiment of the present invention;

FIG. 25A is a screenshot of a Resource Availability and Configuration page or screen according to an embodiment of the present invention;

FIG. 25B is a screenshot of a Service Availability page or screen according to an embodiment of the present invention;

FIG. 25C is a screenshot of a Class Availability and Configuration page or screen according to an embodiment of the present invention;

FIG. 25D is a screenshot of a Package Availability page or screen according to an embodiment of the present invention;

FIG. 26 is a screenshot of a Mobile Service Availability and Configuration page or screen according to an embodiment of the present invention;

FIG. 27 is sequence of screenshots of a process for a Book a Mobile Appointment page according to an embodiment of the present invention; and

FIG. 28 is a screenshot of a Package Configuration page according to an embodiment of the present invention.

Like reference numerals indicate like or corresponding elements or components in the drawings.

### DETAILED DESCRIPTION OF THE EMBODIMENTS OF THE INVENTION

Embodiments according to the present invention are described below by way of block diagrams and flowcharts, and/or screen shots that would be displayed to a user of the system. The screen shots comprise exemplary implementations of an omni-channel application or multi-channel application (herein also referred to as an “App”) or functions or features embodied or executed by the multi-channel App, and/or a platform and/or a business or enterprise application or app.

As will be described in more detail below, the system and method according to an embodiment of the present invention comprises a multi- or an omni-channel application or App (i.e. configured for multiple app stores, e.g. Apple, Google) that is configured to provide one or more of the following functions: (1) appointment booking by conversation; (2) digital consultations utilizing medical forms and/or photographs; (3) customizable services or functions, including—pre-requisite services, follow-up/refill assigned services, recurring, consult required prior, confirmation required option, custom service availability; (4) refill/follow-up/recurring smart tracking; (5) customizable loyalty program & discount codes; (6) photo/video/blog/promo galleries (e.g. a social media channel); (7) ecommerce & in-app payments, deposits and enforced cancellation policy (e.g. an ecommerce or payment transaction channel); (8) in-app chat/direct communication (e.g. chat & push). According to another aspect, one or more the functions can be branded for a client to provide a custom client branded App. The system and method also comprises according to another embodiment a platform which is configured to interface with client devices, i.e. mobile devices such as smartphones and other computing/communication appliances or devices, including desktop and notebook computers. The system further comprises a business or enterprise application (i.e. “app”) implemented as a computer program or Web based application that is utilized by an administrator or staff member associated with the business or enterprise for the custom branded App, as also described in more detail below.

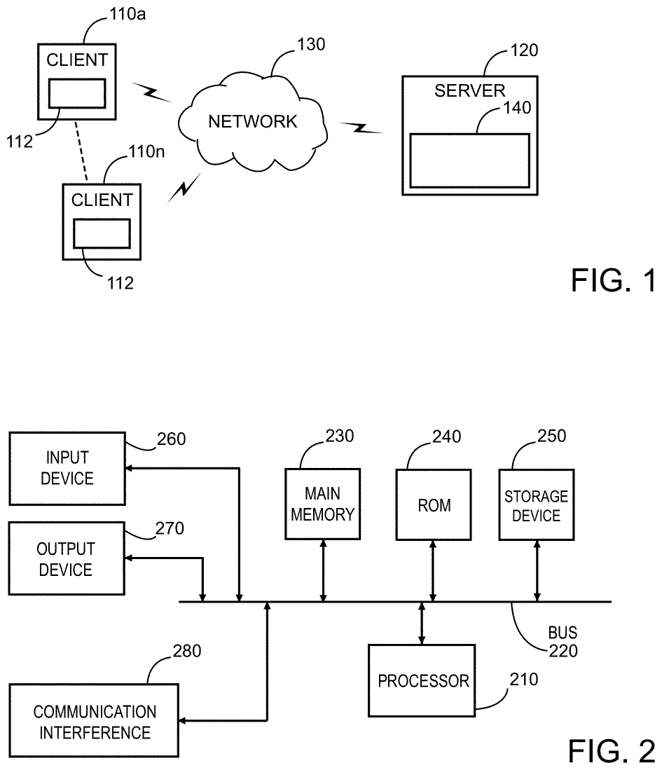

Reference is made to FIG. 1, which shows in diagrammatic form an exemplary operating environment and configuration for implementing and practicing a system and processes according to embodiments of the present invention. The operating environment according to an embodiment and indicated generally by reference 100 comprises a client/server configuration. As shown, one or more client machines or appliances 110, indicated individually by references 110a, 110b, 110c . . . 110n, access a server indicated by reference 120, for example, through a network 130. The network 130 may comprise a local area network (LAN), a wide area network (WAN), the Internet or any combination thereof.

The client machine or appliance 110 may include a device or machine, such as a personal or notebook computer, a wireless mobile communication device or smart phone, a tablet, or another type of computation or communication device, a thread or process running on one of those devices, and/or an object executable by the one of these devices. The server 120 may include a server application or platform 140 configured to provide an omni or multiple app platform. The server application may also comprise the business or enterprise app, for example, implemented as Web-based application. The platform 140 is configured to interface, support, service, generate, customize, host, and/or otherwise support the multi-channel app(s) installed on the client machine, e.g. a smartphone such as the iPhone running the iOS operating system or a Google phone executing the Android OS, in a manner consistent with the embodiments as described in more detail below.

The client machines or devices 110 are configured to run an omni-platform or multi-platform application or “App” which is generated or created by the platform 140. The App is indicated generally by reference 112, and comprises a client interface module and underlying processor(s) configured to provide the features, functionality and processing as described in more detail below. According to an embodiment, the App 112 is implemented with a user interface or GUI (Graphical User Interface) which runs under the App 112 on each of the client machines (e.g. smartphones) 110. According to an embodiment, the App 112 comprises logic, executable processes and functional operations configured to provide the user (i.e. customer or client) of the smart phone or similar device with the features and functionality as described in more detail below.

The functionality and features associated with the multi-channel Apps 112 and/or the platform 140 and/or the server 120 (FIG. 1) and/or the client machines 110 (FIG. 1) and/or the business or enterprise app, and/or the processes and graphical user interface pages, screens or windows, as described herein and in accordance with the embodiments may be implemented in the form of one or more software objects, components, or computer programs or program modules in the server and/or the client machines. Further, at least some or all of the software objects, components or modules can be hard-coded into hardware-based processing units, programmable hardware processors or microprocessors and/or read only memories or other non-volatile physical storage media in the mobile communication device, server and/or other components or modules depicted in the drawings. The specific implementation details of the computer code or software objects and/or program modules will be within the knowledge and understanding of one skilled in the art.

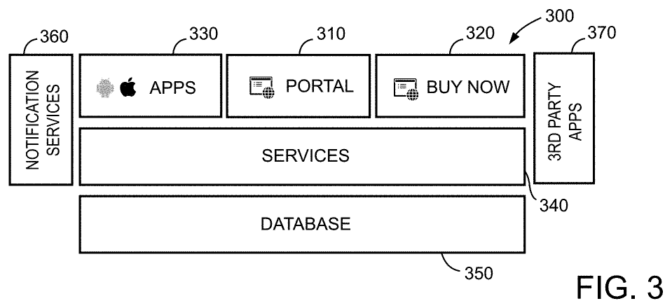

Reference is next made to FIG. 2, which shows an exemplary implementation for a client or server entity (i.e. a “client/server entity”), which may correspond to one or more of the servers 120 and/or the client machines or appliances 110, in accordance with the functionality and features of the embodiments as described in more detail below. The client/server entity is indicated generally by reference 200 and comprises a processor 210, a bus 220, a main memory 230, read only memory or ROM 240, a mass storage device 250, an input device 260, an output device 270 and a communication interface 280. The bus 220 comprises a configuration (e.g. communication paths or channels) that permits communication among the elements or components comprising the client/server entity 200.

The processor 210 may comprise a processor, microprocessor, microcontroller or other type of hardware-based device or processing logic that is configured to interpret and/or execute instructions. The main memory 230 may comprise a random access memory (RAM) or other types of dynamic storage device that is configured to store information and/or instructions for execution by the processor 210. The ROM 240 may comprise a conventional ROM device or another type of static or non-volatile storage device configured to store static information and/or instructions for use by the processor 210. The storage device 250 may comprise a disk drive or other mass storage device such as a magnetic and/or optical recording medium and its corresponding drive or controller.

The input device 260 may comprise a device or mechanism configured to permit an operator or user to input information to the client/server entity 200, such as, a keyboard, a mouse, a stylus, voice recognition and/or biometric mechanisms, etc. The output device 270 may comprise a device or mechanism that outputs information to the user or operator, including a display, a printer, a speaker, etc. The communication interface 280 may comprise a transceiver device or mechanism, or the like, configured to enable the client/server entity 200 to communicate with other devices and/or systems. For instance, the communication interface 280 may comprise mechanisms or devices for communicating with another machine, appliance or system via a network, for example, the network 102 (FIG. 1).

As will be described in more detail below, the client/server entity 200, in accordance with embodiments according to the present invention, may be configured to perform operations or functions relating to the process of generating, configuring, operating, hosting, servicing, managing or otherwise supporting an omni-channel application or app. The client/server entity 200 may be configured to perform these operations and/or functions in response to the processor 210 executing software instructions or computer code contained in a computer-readable medium, such as the memory 230. The computer-readable medium may comprise a physical or a logical memory device or medium.

The software instructions or computer code may be read into the memory 230 from another computer-readable medium, such as a data storage device 250, or from another device or machine via the communication interface 280. The software instructions or computer code contained or stored in the memory 230 is configured to instruct or cause the processor 210 to perform or execute processes and/or functions as described in more detail below. In the alternative, hardwired circuitry, logic arrays, and the like, may be used in place of or in combination with software instructions to implement the processes and/or functions in accordance with the embodiments of the present invention. Therefore, implementations consistent with the principles of the embodiments according to the present invention are not limited to any specific combination of hardware and/or software. The particular implementation details will be readily within the understanding of one skilled in the art.

Reference is now made to FIG. 3, which shows in block diagram form a high-level architectural configuration for the system and method for a multiple-channel (“omni-channel”) App, platform and business or enterprise application (“app”) according to an embodiment of the present invention and indicated generally by reference 300. As shown, the system comprises a portal module or functional component 310, a buy now module or functional component 320, an apps module or functional component 330, a services module or functional component 340 and a database module 350. The system may also include a notification services module or component indicated by reference 360 and a third-party apps module or component indicated by reference 370.

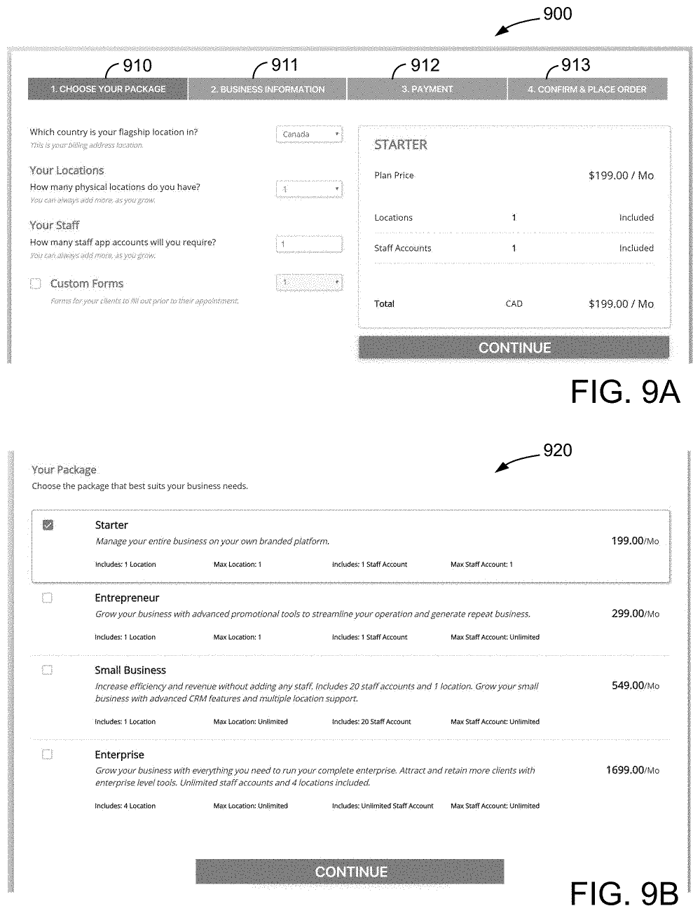

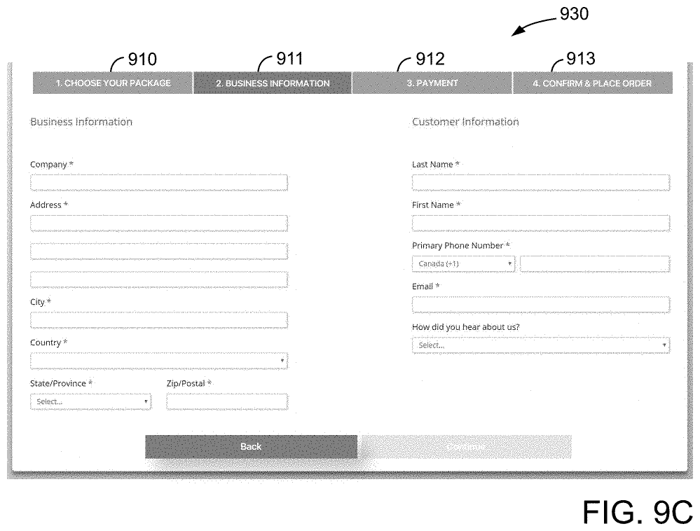

The buy now module 320 is configured to provide a user (e.g. client with the capability to purchase a subscription to the services and functions provided by the platform, as described in more detail below with reference to FIGS. 9A to 9D.

Reference is next made to FIG. 9A which shows a “Buy Now” screen or page indicated by reference 900. The Buy Now page 900 is accessed from a landing page for example by clicking a “Buy Now” tab. According to an exemplary implementation, the Buy Now page 900 provides a user with a number of available subscription tiers or packages, which are accessed using a Choose Your Package tab 910 as shown. As also shown, the Buy Now page 900 also includes a “Business Information” tab 911, a “Payment” tab 912 and a “Confirm & Place Order” tab 913. In response to the user clicking the Choose Your Package tab 910, the system is configured to display the available packages in a Subscription Package page, for example, as depicted in FIG. 9B and indicated by reference 920. The Subscription Packages comprise a “Starter” package or tier, an “Entrepreneur” package or tier, a “Small Business” package or tier and an “Enterprise” package or tier. As shown, the user has selected the “Starter” package which includes “Max Location 1” and “Max Staff Account 1”. According to exemplary implementation, when Locations or Staff are increased, certain subscription tiers or packages are not available. For example, when the Location selection is changed from 1 to 3, and Users is changed from 1 to 15, the “Starter” tier subscription and the “Entrepreneur” tier subscription are no longer available. Once the user “Business Information” is collected and the payment information entered via a payment page or screen accessed by the clicking the Payment tab 912, the user clicks the Confirm & Place Order tab 913. In response, the system processes the order and payment and if valid, the system generates a confirmation page, for example, as depicted in FIG. 9D and indicated by references 940 and 942, respectively.

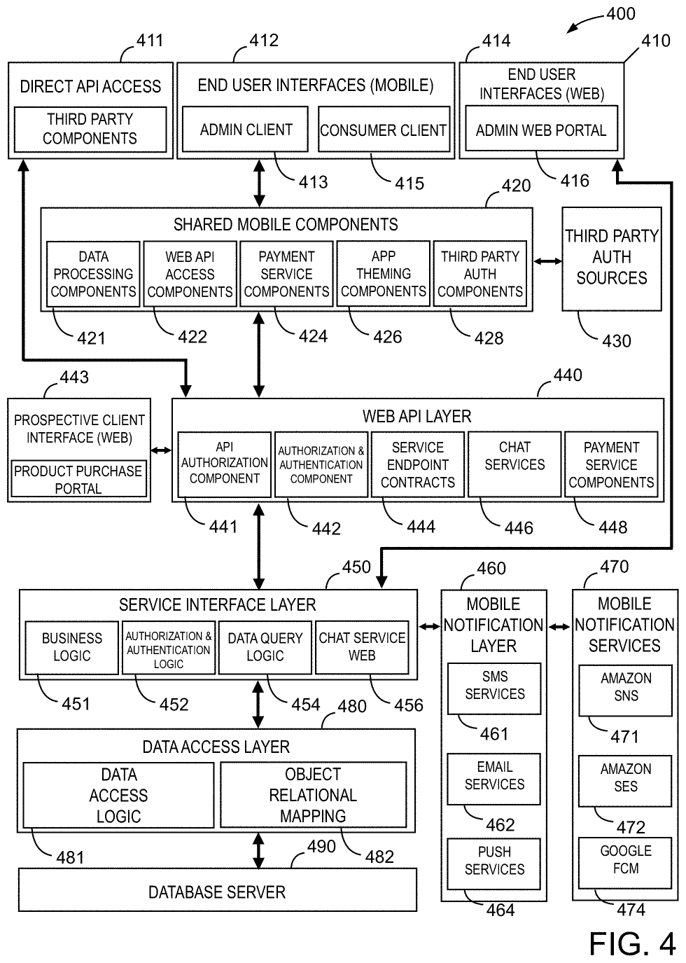

Reference is next made back to FIG. 4, which shows in block diagram form an exemplary machine/software implementation for the high-level architecture 300 for the system and method for an omni-channel app and platform/business app according to an embodiment of the present invention and indicated generally by reference 400. The system 400 comprises a portal module or functional component indicated by reference 410 and further comprising a mobile end-user interface 412 and a web (i.e. browser based) end-user interface 414. The mobile end-user interface 412 includes an admin client module 413 and a consumer client module 415, which are configured to provide both administrative interface functions and consumer interface functions to mobile end-users (i.e. clients). The web-based end user interface 414 is configured with an admin web portal module, indicated by reference 416.

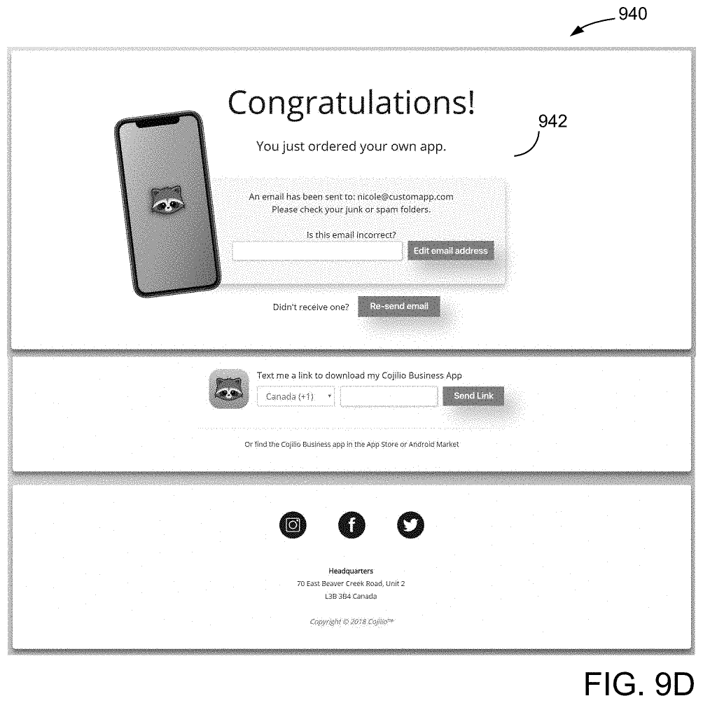

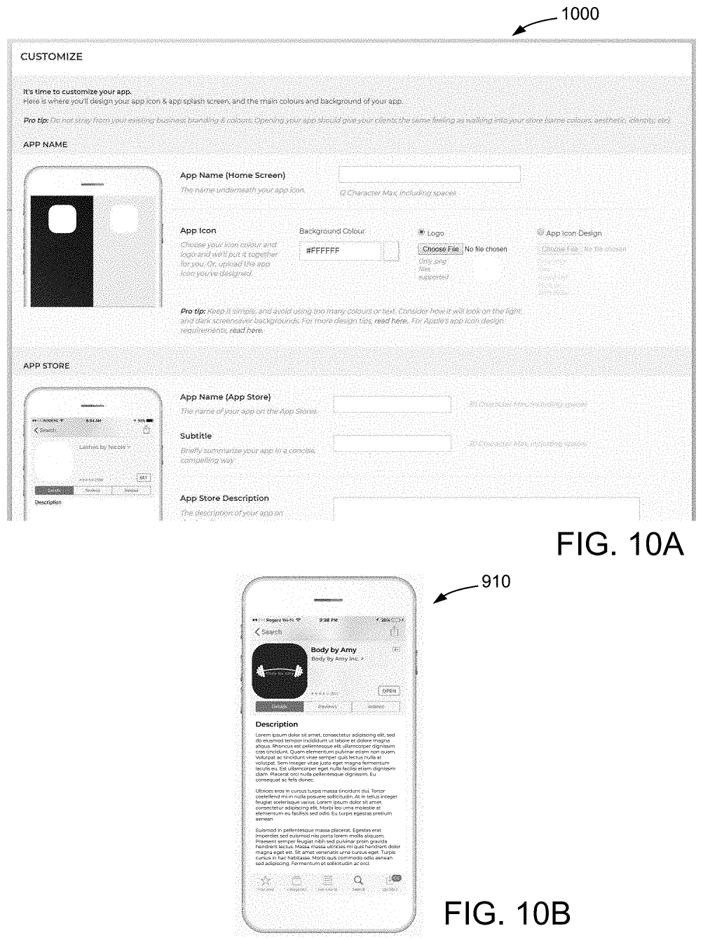

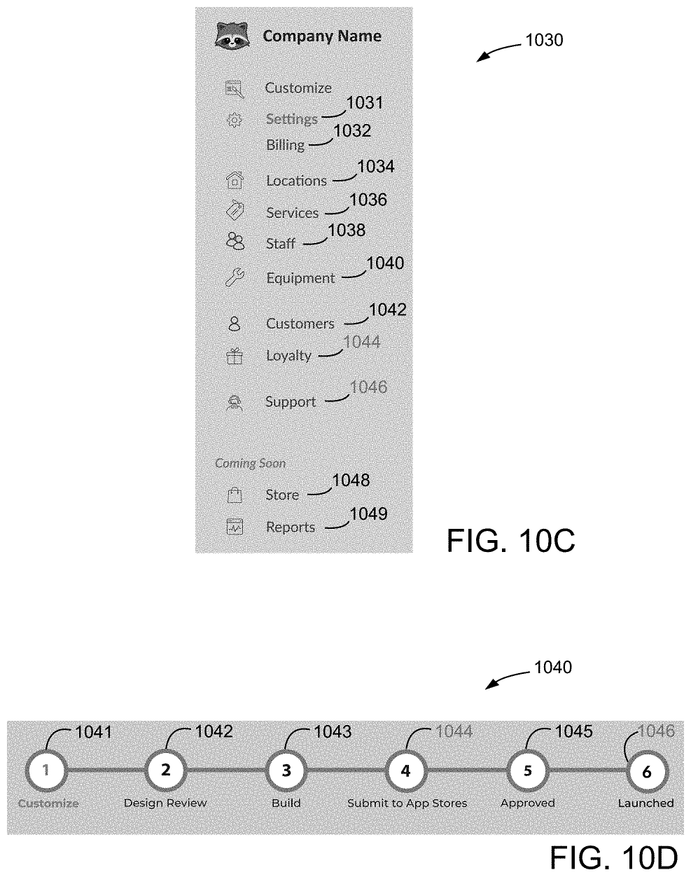

The mobile end-user interface 412 interfaces to a shared mobile components module indicated by reference 420 as shown in FIG. 4. According to an exemplary implementation, the shared mobile components 420 comprise data processing components 421, web API access components 422, payment service components 424 and app theming components 426. The system is further configured to generate an image of the multi-channel app as configured by the user, for example, as depicted in FIG. 10B and indicated by reference 910. According to another aspect, the shared mobile components module 420 includes a third-party authentication component indicated by reference 428, which is configured to install a third-party authentication component in the multi-channel App, for example, utilizing the user's Facebook account or Google account. As shown, the third-party authentication component 428 is configured to interface to various third-party authentication sources, e.g. Facebook, Instagram, Google, Microsoft, indicated generally by reference 430 in FIG. 4.

As shown in FIG. 4, the shared mobile components module 420 interfaces to a Web API layer indicated by reference 440. The Web API layer 440 is configured to build or install one or more Web API's (Application Programming Interfaces) for the multi-channel App and/or the browser-based application. According to an exemplary implementation, the Web API layer 440 comprises an API Authorization Component 441, an Authorization and Authentication component 442, a Service Endpoint Contracts component 444, a Chat Services component 446 and a Payment Service component 448. As shown, the Web API layer 440 also interfaces to a Direct API Access module 411 for accessing Third Party API Component(s). According to another aspect, the system includes a Prospective Client Web Interface module 443, which is configured to provide a Product Purchase Portal for prospective clients and is operatively coupled to the Web API layer 440.

As shown in FIG. 4, the system architecture 400 includes a service interface layer 450 below the Web API layer 430. The service interface layer 450 is configured to provide a number of services to the API layer 430, and the service modules include a Business Logic module 451, an Authorization and Authentication Logic module 452, a Data Query Logic module 454 and a Chat Service Hub module 456. As shown, the Service Interface layer 450 also interfaces to and services the End User Interfaces module 414 and the Admin Web Portal component 416.

Referring still to FIG. 4, the system architecture 400 may also include a Mobile Notification Layer 460 which is configured to provide an interface with Mobile Notification Services indicated generally by reference 470. According to an exemplary implementation, the mobile notification services 470 include Amazon SNS 471, Amazon SES 472 and/or Google FCM 474. The Amazon Simple Notification Service (SNS) 471 is a web service that coordinates and manages the delivery or sending of messages to subscriber endpoints or clients. The Amazon Simple Email Service (SES) 472 is a cloud-based email sending service particularly suited for digital marketers for sending marketing, notification and transactional emails. The Google Firebase Cloud Messaging (FCM) service 474 is a cloud-based cross-platform messaging system.

The Mobile Notification Layer 460 is configured to provide notifications to the Service Interface Layer 450 from the Mobile Notification Services 470. According to an exemplary implementation, the notification services comprise SMS (Short Message Service) Services 461, Email Services 462 and Push Services 462.

As shown in FIG. 4, the system architecture 400 includes a Database server 490 which is accessed through a Data Access Layer indicated generally by reference 480. According to an exemplary embodiment, the Data Access Layer 480 comprises a Data Access Logic module or component 481 and an Object Relational Mapping module or component 482.

Once the user has set up an account (as described above with reference to FIGS. 9A to 9D), the system is configured to generate an activation email which is sent to the user and includes a link to login using a login page (e.g. “online.cojilio.com”) for the business portal 310 (FIG. 3) using their username (e.g. email address) and a temporary password (e.g. issued by the system). In response to the user entering valid credentials, the system redirects the user to a Customize page 1000 for example as shown in FIG. 10A.

Referring to FIG. 10A, the Customize page 1000 is configured to allow a user to build, customize and/or modify a multi-channel App (for example, as indicated by reference 910 in FIG. 10B) associated with or generated for their business or enterprise. According to an exemplary implementation and as depicted in FIG. 10A, the Customize page 1000 is configured to allow the user to design the app icon and app splash screen and the main colors and background of the App. As shown, the Customize page 1000 allows the user to specify “App Name”, “App Icon”, “Background Color”, “Logo”, “App Icon Design”, “App Name (App Store)” and/or “App Store Description”. According to an exemplary implementation, the App Name (i.e. Home Screen) and the App Icon are required elements. For the App Name, the system requires the user to input an app name (50 character max) for the App Store & Google Play Store. For the App Store Description, the user inputs the description for their app 910. Once the user has entered the App Name and App Store Description in the Customize Page 1000, the system is configured to generate a preview of the App 910 for example in the App Store iPhone Diagram as depicted in FIG. 10B. The user selects a background color using the Splash Background input. According to another aspect, the system utilizes a pre-built color template to facilitate building/customizing the App by eliminating selected inputs or actions required of the user, for example, selection of Colour Scheme, App Background, Top Menu Icons, Footer Menu, Footer Menu Icons.

The Customize page 1000 may include a progress bar for example as depicted in FIG. 10D and indicated by reference 1040. The progress bar 1040 is configured to display the progress of the multi-channel app 910 from the customization and build to the submission and launch on app store(s). According to an exemplary implementation, the progress bar comprises the following progress steps and indicators: (1) Customize (Design your app) 1041; (2) Design Review 1042; (3) Build 1043; (4) Submit to App Stores 1044; (5) Approved 1045; and (6) Launched 1046.

Once the user has entered/provided the inputs/selections for the required fields, the system is configured to enable a “Submit App Design” button. The user submits the app design, the building of the App moves to the Business Setup stage. According to an exemplary implementation, the system generates an email with a link to a guided business setup process which comprises setting up the company, location(s) and associated resources. The Company Setup comprises adding time zone, industry, currency and billing. The Add Locations function is configured to allow a user to create a location and according to an exemplary implementation comprises the following required input fields: “Location name”, “First name”, “Last name”, “Email”, “Address line 1”, “Country”, “State/Province”, “City”, “Zip/Postal”. According to another aspect, the system is configured to allow the user to specify “Hours of Operation”. If the Hours of Operation are set, then customers will only be able to access services (e.g. book appointments) for the associated location between the set hours of operation. In addition to Hours of Operation, “Holiday Hours” may also be set by the user.

Reference is next made to FIG. 10C, which shows a screenshot of a Portal Side Menu according to an embodiment of the present invention and indicated by reference 1030. The Portal Side Menu 1030 is configured for the business or enterprise and comprises a list of links to pages for setting up or configuring the App. According to an exemplary implementation, the Portal Side Menu 1030 comprises a “Settings” page link 1031, a “Billing” setup page link 1032, a “Locations” setup page link 1034, a “Services” setup page link 1036, a “Staff” setup page link 1038, an “Equipment” setup page link 1040, a “Customers” setup page link 1042, a “Loyalty” setup page link 1044 and a “Support” setup page link 1046. The Portal Side Menu 1030 may also include a “Coming Soon” function(s) field, for example, a “Store” setup page link and a “Reports” setup page link, as also shown in FIG. 10C.

The Services setup page link 1036 is configured to open a Services Page. According to embodiment, the system is configured to provide the capability to define or create services offered by the business or enterprise and accessible by a customer through the App.

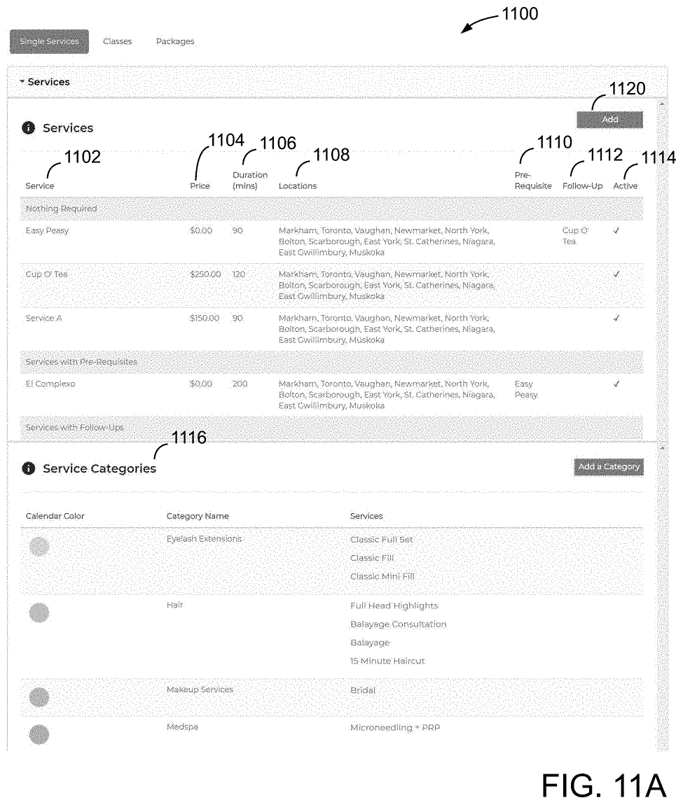

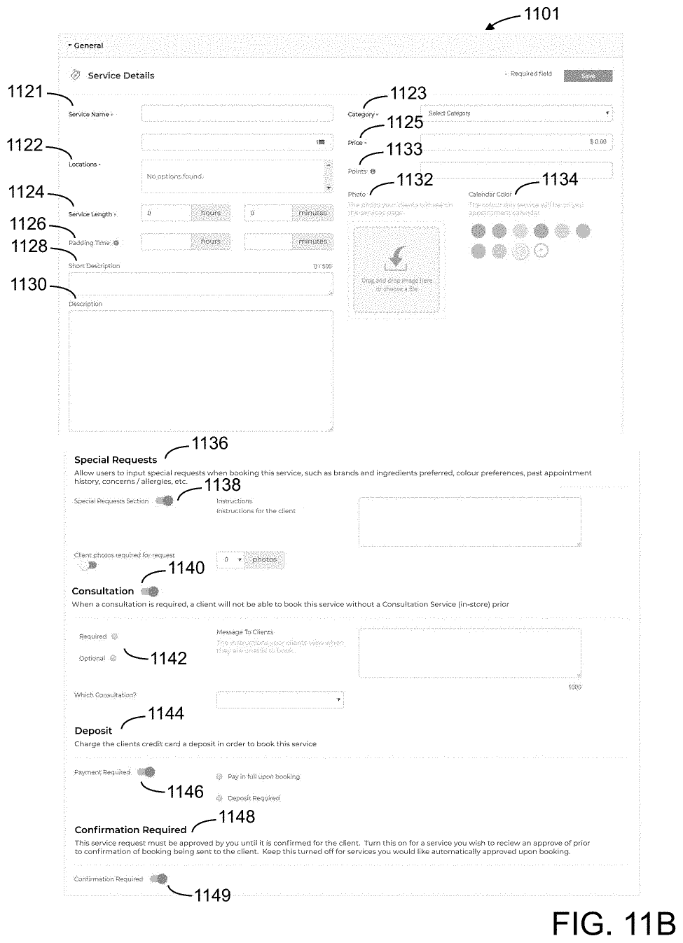

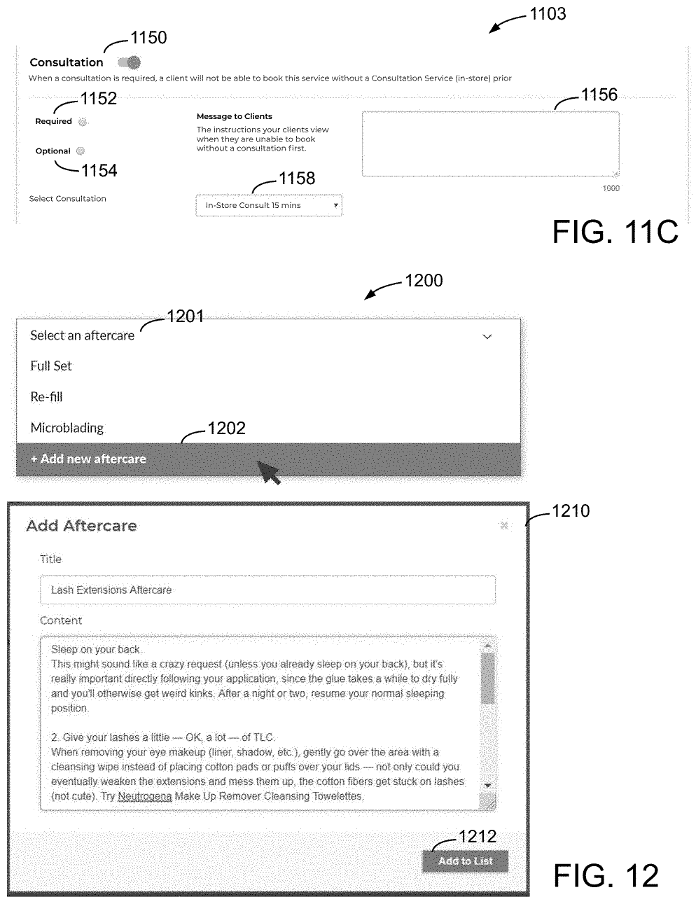

Reference is made to FIG. 11A, which shows a Services Page according to an embodiment of the invention and indicated generally by reference 1100. The Services Page 1100 is configured to provide a user with the capability to build or populate the App with services that are available or offered by the business or enterprise associated with the app. In an exemplary implementation as shown in FIG. 11A, the Services Page 1100 comprises a list of services available from the business (i.e. vendor) under Service 1102, together with a Price listing 1104, a Duration listing 1106, a Location 1108 (e.g. the location where the service is provided if the business or vendor has multiple locations or venues), a Prerequisite indicator 1110 (e.g. a pre-requirement or condition for taking or using the service), a Follow-Up indicator 1112 (e.g. certain services will require a follow-up visit, examination, or treatment). As shown, the Services Page 1100 is also configured with an Active setting 1114, which allows a user to active or deactivate the service being offered. The Services Page 1100 also includes a Service Categories 1116, which can comprise a drop-down list which lists the available service categories as shown in FIG. 11A.

The Services Page 1100 includes an Add a Service tab 1120. To add a service, the user clicks the Add a Service tab 1120 in order to add a service for the App associated with the user's business or enterprise. In response, the system is configured to generate and display a Service Details Page for example as shown in FIG. 11B and indicated by reference 1101. According to an exemplary embodiment, the Service Details Page 1101 includes the following required input fields for defining or configuring a service: “Service Name” input field 1121, “Location(s)” input field 1122, “Category” input field 1123, “Service Length” input field 1124, “Price” input field 1125, and a “Short Description” input field 1128. The service may also include a number of optional parameters or definitions. According to an exemplary embodiment, the optional input fields include: “Padding Time” input field 1126, an “Extended Description” input field 1130, a “Photo” input 1132, a “Calendar Colour” selection input 1134, a “Special Requests” input field 1136, an “Allow special requests” control input 1138, a “Consultation” input 1140, a “Consultation Required” control or enable input 1142, a “Deposit” required input 1144, a “Payment Required” input 1146, a “Confirmation Required” input 1148, and a “Require Confirmation” control or enable input 1149, as shown in FIG. 11B. Once the user has configured or defined the service according to the above-noted parameters or controls, the user clicks a “Save” button to save the service and the system configures the service for the app.

Reference is next made to FIG. 11C, which shows an embodiment of a Consultation Configuration Page according to an embodiment of the present invention and indicated generally by reference 1103. When the Consultation requirement is turned on or enabled, i.e. using the Consultation Required input 1142 (FIG. 11B), the system is configured to generate the Consultation Configuration Page 1103. As shown, the Consultation Configuration Page 1103 is configured with a Consultation setting button 1150. The consultation may be further configured as “Required” with button 1152 or “Optional” with button 1154, as shown in FIG. 11C. If the Required button 1152 is set, then a customer is required to first book a consultation before the actual service can be booked or purchased, for example, as described in more detail below. As shown, the Consultation Configuration Page 1103 includes an additional required input field: “Message to Clients” as indicated by reference 1156, which is configured to allow the user to input or compose a message that is displayed or otherwise provided to the customer. The Consultation Configuration Page 1103 may further include a consultation period setting 1158, which allows the user to define a time limit for the consultation, for example, 15 minutes for an in-store consultation, as shown in FIG. 11C.

Reference is next made to FIG. 12, which shows a screenshot of a Select Aftercare Page according to an embodiment of the present invention and indicated generally by reference 1200. According to an exemplary implementation, the Select Aftercare Page is configured as a “dropdown” list and includes an “Add new aftercare” input indicated by reference 1202. In response to a user clicking the Add new aftercare input 1202, the system is configured to generate an Add Aftercare Page or window as indicated by reference 1210. The Add Aftercare Page 1210 is configured to allow the user to enter a name or descriptor for the new aftercare service or product and then save the new service or product to the Select Aftercare Page 1200 by clicking an “Add to List” input or button indicated by reference 1212. The system reconfigures the app with the newly added aftercare service or product, which then becomes available for customers once the App is updated on their respective devices, i.e. smart phones.

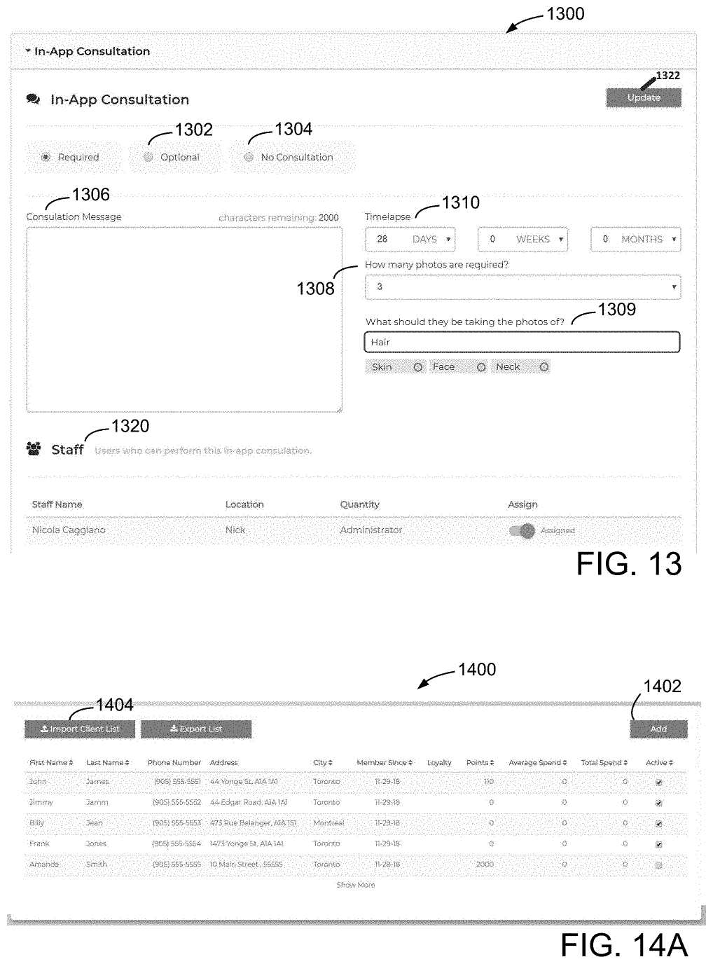

Reference is next made to FIG. 13, which shows an In-App Consultation Page according to an embodiment of the present invention and indicated generally by reference 1300. The In-App Consultation Page 1300 is configured to allow a user to set-up or configure or revise a consultation with a customer using the app. According to an exemplary implementation, the App can be configured with a mandatory consultation comprising a “Required” consultation 1301, and an “Optional” consultation 1302, or the App can be configured without a consultation comprising “No Consultation” as indicated by reference 1304. According to an embodiment, the In-App Consultation Page 1300 includes a Consultation Message input window indicated by reference 1306. The Consultation Message window 1306 is configured to allow the user to specify additional instructions or information associated with the consultation. For instance, the consultation message comprises instructions for a customer to “Please take a photo of the left, right and front of your face in natural sunlight without any makeup on”, as shown in FIG. 13. As shown, the In-App Consultation Page 1300 may further include a “How many photos are required?” input, for example “3”, as indicated by reference 1308. According to an exemplary implementation, the In-App Consultation Configuration Page 1300 also includes a Photo Selection panel indicated generally by reference 1309. The Photo Selection panel 1309 is configured to allow the user to define the types of photos required for the in-app consultation, for example, “Skin”, “Face” or “Neck” photos as shown. According to another aspect, the In-App Consultation Page 1300 may include a “Timelapse” input 1310 for defining a time-frame associated with the consultation in “Days”, “Weeks” and/or “Months” as depicted in FIG. 13. According to another aspect, the In-App Consultation Page 1300 may be configured with a “Staff” selection input indicated by reference 1320. The Staff input allows a user to configure the consultation on the app with particular individuals, e.g. staff or employees of the business or enterprise, who are trained, experienced, qualified or otherwise suited or available to perform or conduct the service for a customer. Once the user is satisfied with the configuration or parameters associated with the consultation, the user clicks an “Update” input or button 1322 which saves the In-App consultation configuration to the system and the system is configured to generate or update the App with the In-App consultation.

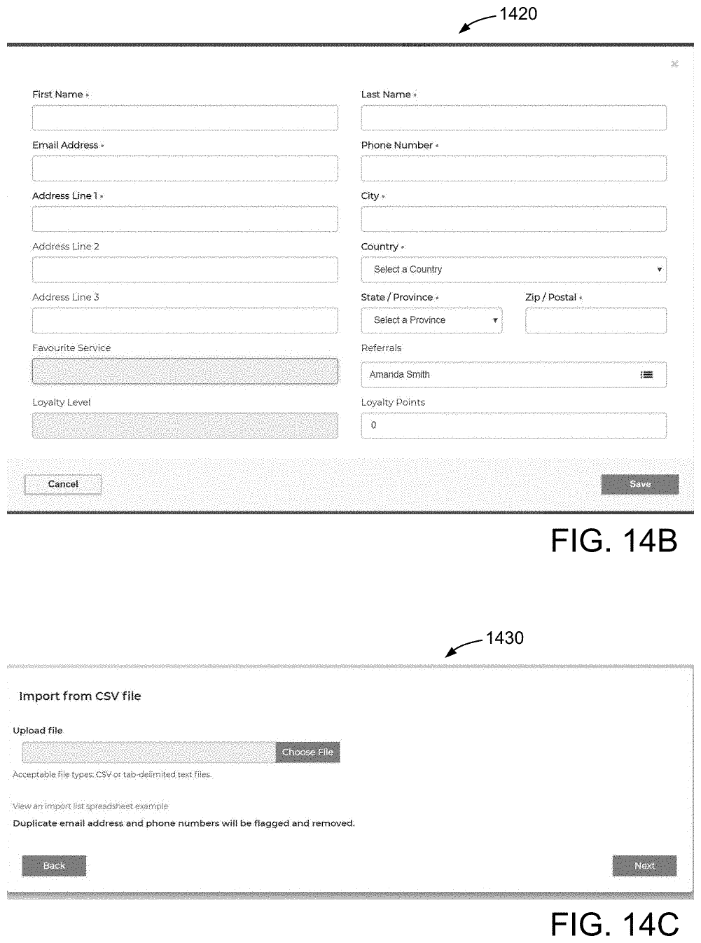

Reference is next made to FIG. 14A which shows a Setup Customers (Clients) Page as indicated by reference 1400. The Setup Customers Page 1400 is accessed from the Portal Side Menu 1030 (FIG. 10C) and is configured to provide the functionality to create new customers or clients. According to an exemplary implementation, the Setup Customers Page 1400 includes an Add button or control 1402 configured to allow the user to add one customer or client at a time. The Setup Customers Page 1400 also includes an Import Client List button or control 1404 which is configured to allow the user to import or upload multiple customers or clients at once, i.e. a list of customers or clients, for instance utilizing a xxxx.csv file. According to an exemplary implementation, the system is configured to generate and display an Add New Customer popup window in response to the user clicking the Add button 1402, for example, as shown in FIG. 14B and indicated by reference 1420. The system is configured to generate to an Import from CSV File window as shown in FIG. 14C and indicated by reference 1430.

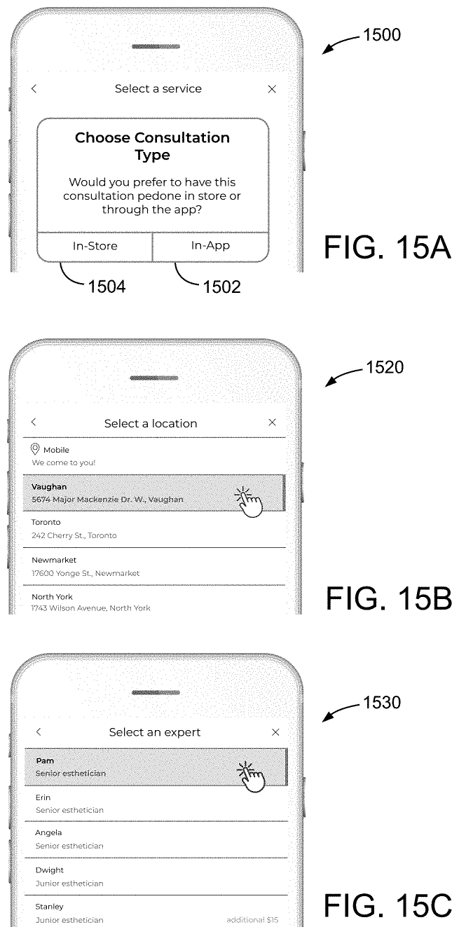

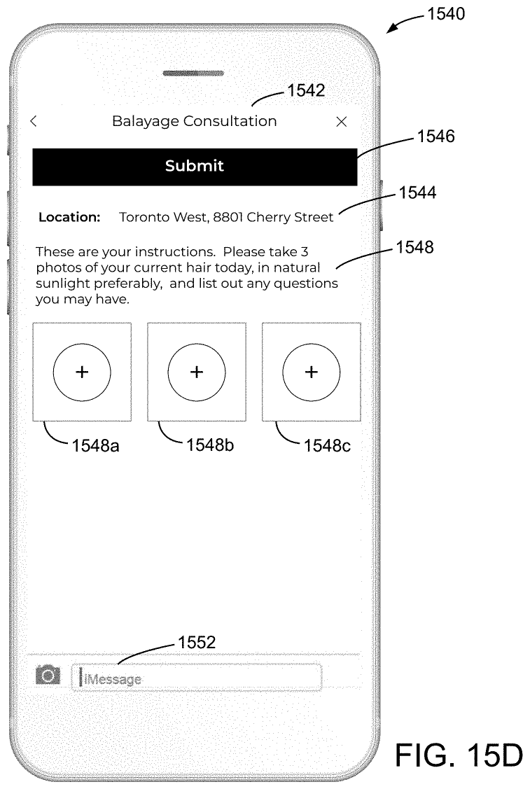

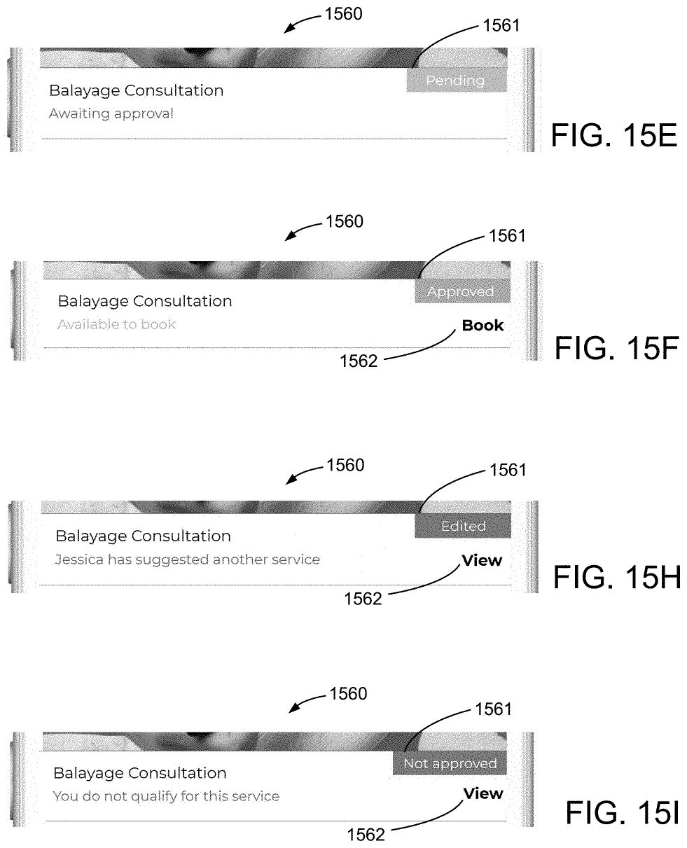

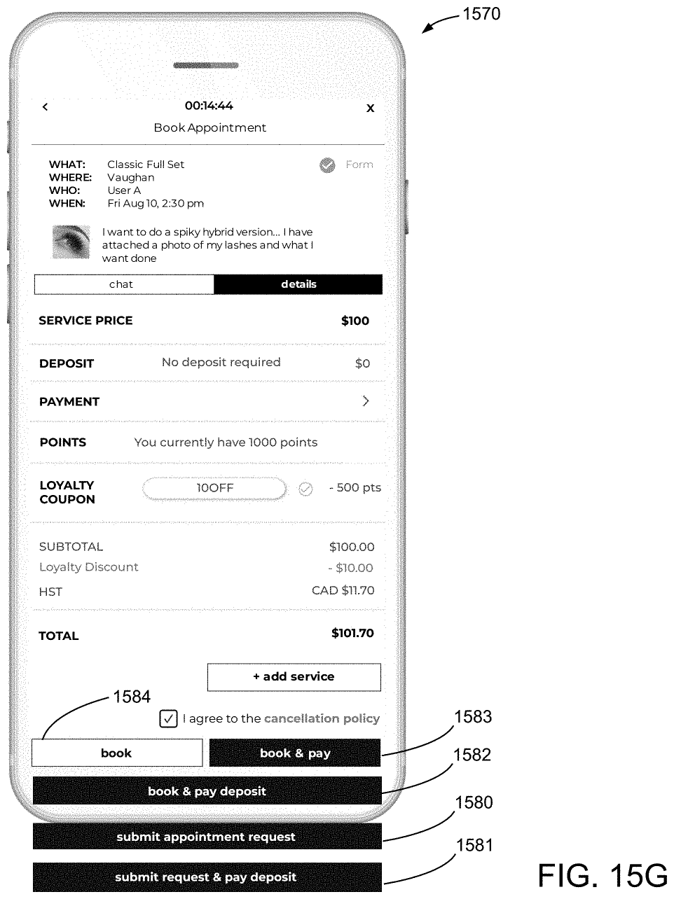

Reference is next made to FIG. 15A which shows a screen shot of a Select Consultation popup window indicated generally by reference 1500. If a service has been configured with both “In App Consultation” and “In Store Consultation” enabled (for example as described above), then the Select Consultation popup 1500 is configured with an In-App Consultation select button 1502 and an In-Store Consultation select button 1504 as shown. If the customer (i.e. client) selects In-Store Consultation 1504, the App is configured to launch a Book Appointment Wizard for example as depicted in FIG. 15C and indicated by reference 1530. According to an exemplary implementation, the service selected on the Services Page is preselected as the service in the Book Appointment Wizard 1530. The next step, i.e. Step 2, involves choosing location. The App is configured to display all locations where the service is available or if the service is mobile based. Step 3 in the Book Appointment Wizard 1530 comprises choosing a staff member. According to an exemplary implementation, the App is configured to list all users assigned to the selected service (location or mobile enabled) and available for selection by the customer or client. Step 4 comprises displaying the available day & time slots for selection by the customer. According to an exemplary implementation, all available dates & time slots for the staff member are listed starting with the soonest date & time. The App may be configured with a Special Requests page for the service in a Step 5 of the wizard. The last step, i.e. Step 6, comprises a ‘Review & Book’ step in a Review screen which is generated or displayed by the App, for example as depicted in FIG. 15G and indicated by reference 1570. The Review screen 1570 is configured to summarize all the selections made by the customer, e.g. in Steps 1 to 5. As shown, the Review screen 1570 is configured to display Price, Deposit (if a deposit is defined requirement configured through the portal, then payment for the deposit is collected from the customer's credit card once the request is approved by an administrator), Payment (from customer's credit card on file), Points (the customer's loyalty points balance—if the loyalty program function is enabled), Available Loyalty coupons (created or configured under Discounts in the portal), Subtotal, Loyalty Discount (if applied), Tax and Total. To initiate the appointment request, the Review screen 1570 includes a “Submit Appointment Request” button indicated by reference 1580.

If the customer or client selects the In-App Consultation 1502 in the Select Consultation popup window 1500 (FIG. 15A), then the App is configured to launch an In-App Consultation wizard. The first step in the wizard comprises selecting a location in an In-App Consultation Choose Location page as shown in FIG. 15B and indicated by reference 1520. Following the selection of the location by the customer, the App displays an In-App Consultation Page for example as shown in FIG. 15D and indicated by reference 1540. The In-App Consultation Page 1540 shows the selected Service Name 1542 and the selected Location Name 1544. The In-App Consultation Page 1540 includes a Book button 1546, which is disabled until the consultation is approved, for instance, by an administrator. According to an exemplary implementation, the In-App Consultation 1540 requires the client to submit three photos which are dropped into respective photo placeholders 1548, indicated individually by references 1548a, 1548b and 1548c. The In-App Consultation page 1540 includes a Submit button 1550. The Submit button 1550 is disabled until the In-App Consultation requirements are met, for example, three photos are loaded by the customer. Once completed, the Submit button is enabled and the customer submits the in-app consultation. The In-App Consultation page 1540 may include a message input field 1552 which allows the customer to type messages. Once submitted, the in-app consultation status remains “Pending” 1561 until approved by an administrator, as shown in a Client In-App Consult Status Bar 1560 in FIG. 15E. Upon reviewed by an administrator and approved or edited, a push notification is generated and the in-app consultation status changes to “Approved” 1561′ and a Book button 1562 is enabled as shown in the Client In-App Consult Status Bar 1560 in FIG. 15F. In response to the customer clicking the Book button 1562, the App launches the Book Appointment Wizard at Step 3 (as described above).

Reference is next made to FIG. 15H, which shows the Client In-App Consult Status Bar with an “Edited” status as indicated by reference 1561. The Edited status is generated in response to an administrator editing the service, for example, “Jessica has suggested another service” and the customer is able to view the administrator message or suggestion using a “View” button indicated by reference 1562. In FIG. 15I, the Client In-App Consult Status Bar is configured to show a “Not approved” status, for example, on the basis that the customer does not qualify for the service. The customer may view any additional comments by tapping a “View” button 1562 as shown.

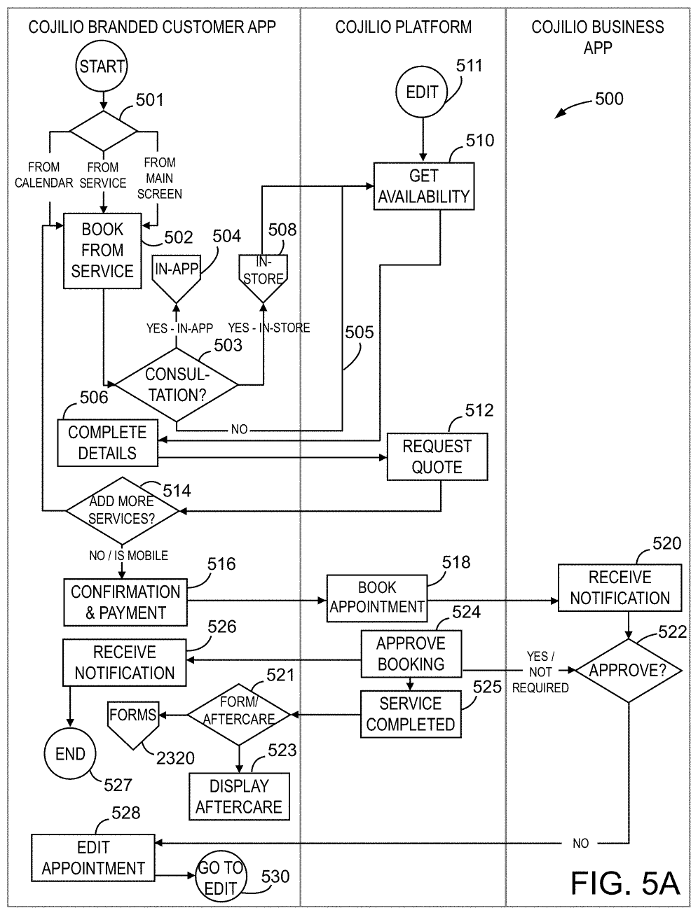

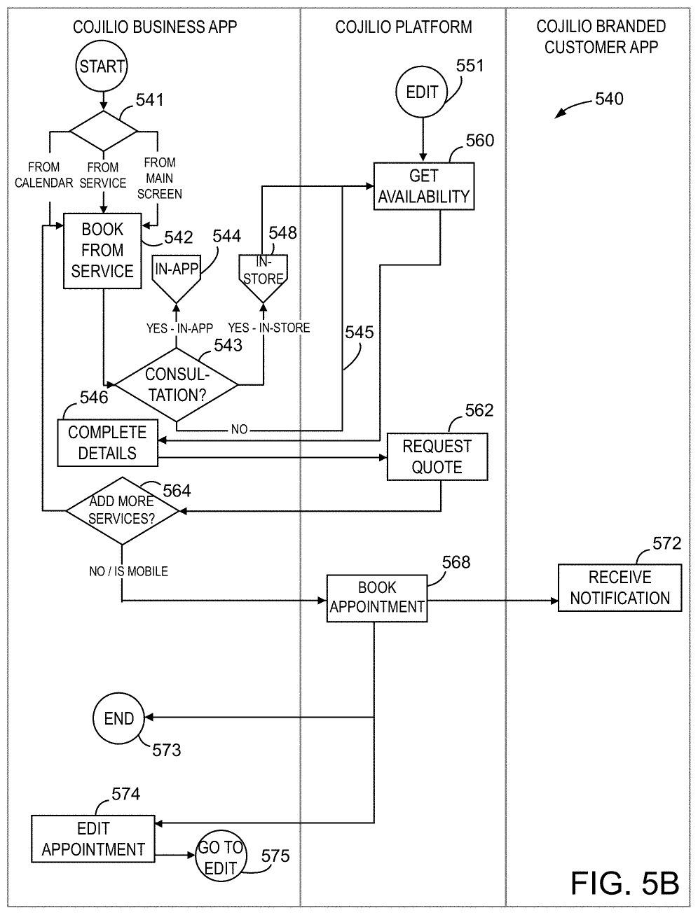

The operation of the system and/or the App and/or the platform and/or the business or enterprise app according to exemplary embodiments is described in further detail with reference to the flowcharts shown in FIGS. 5A-5B, FIG. 6, FIG. 7, FIGS. 8A, 8B, 8C, 8D and 8E, FIGS. 23A-23C, FIG. 24, FIGS. 25A-25D and FIGS. 26-28.

Reference is first made to FIG. 5A, which shows in flowchart form a process or method for booking an appointment utilizing a Customer App (e.g. a custom branded App) generated or configured according to an embodiment of the present invention. The booking process is indicated generally by reference 500. The booking process 500 is executed by the Customer App interfacing to the platform and/or business or enterprise application or app, as described in more detail below, and comprises the following steps.

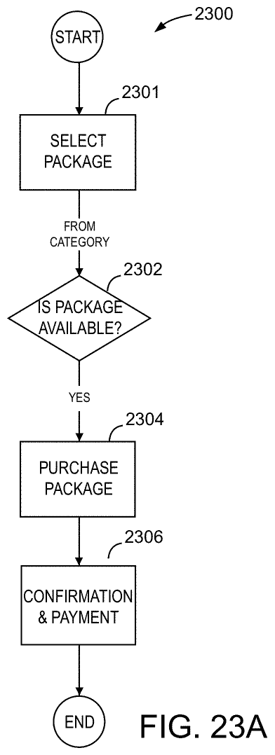

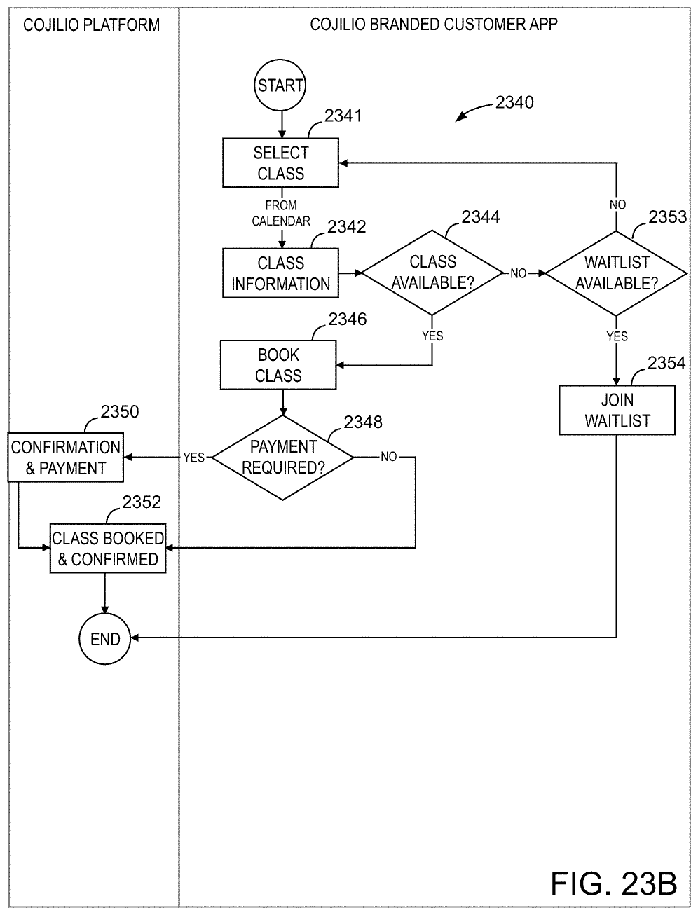

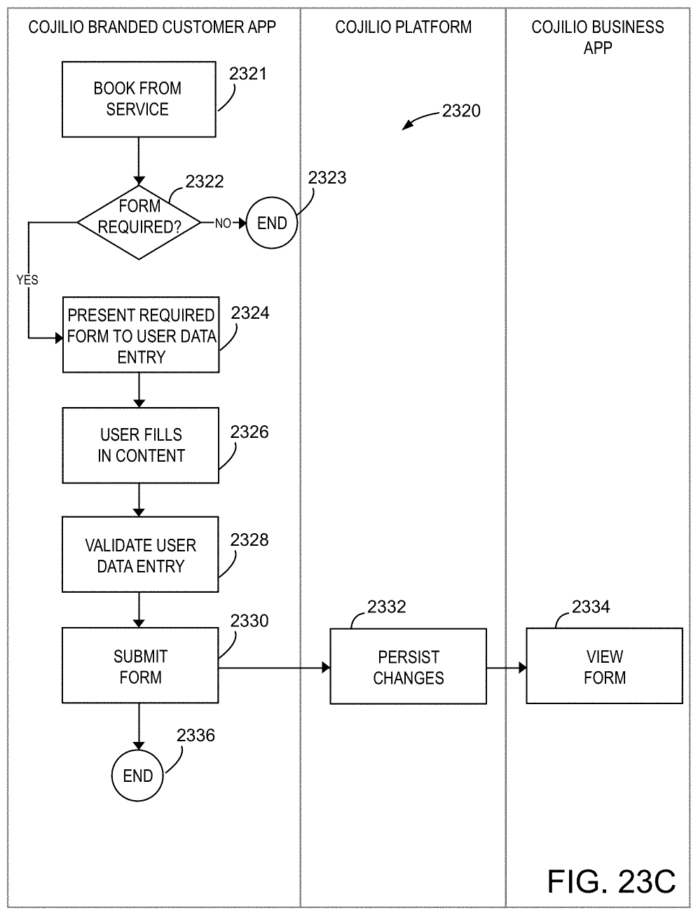

According to an exemplary implementation, an appointment booking can be initiated from a calendar installed in the Customer App or from the main screen or home page of the App, as indicated by decision block 501. The next step involves booking a service as indicated by reference 502. If the service to be booked involves a “Consultation” (for example, as described above), then a determination is made in decision block 503 if the consultation comprises an “In-App” consultation 504 or an “In-Store” consultation 508. If an In-App consultation, then the next step in the booking process involves completing the consultation details utilizing the App as indicated by reference 506. If, on the other hand, the consultation comprises an In-Store consultation, then the availability of In-Store consultations is determined by the platform as indicated by reference 510. According to another aspect, the availability, e.g. available time slots, for In-Store consultations can be edited or revised, for example, by an administrator on the platform, as indicated by reference 511. The availability, i.e. available dates and times, are updated on the App, and the customer completes the booking details for the appointment as indicated in block 506. If the service does not require, or offer, a consultation, the App gets the availability directly, as indicated by reference 505, from the platform in block 510. The next step in the appointment booking process 500 comprises the App requesting a quote for the selected service (and/or consultation) from the platform as indicated by reference 512. Next, the App is configured to present the customer or client with the option of adding more services as indicated by decision block 514. If the customer decides to add or book another service, then processing moves to the book service block 502 and steps 506 to 512 are repeated as described above. If, on the other hand, the customer doesn't wish to add any more service(s), then the next steps in the appointment booking process 500 comprises “Confirmation and Payment” by the customer on the App as indicated by block 516. The App transmits a “Book Appointment” notification to the platform as indicated by block 518, and the business enterprise app receives a notification as indicated by block 520. As shown, the appointment booking process 500 may include an approval step executed by the business enterprise app, as indicated by reference 522. The Approve step 522 may be configured for all available services being booked or for selected service(s). If the Approve step 522 is required, then the platform generates a booking approval, as indicated in the “Approve Booking” block 524. The Approve Booking notification is transmitted to and received by the App, as indicated by block 526, and the appointment booking process 500 ends on the App as indicated by reference 529. These steps are also executed if the appointment booking does not require approval. If an appointment booking request is not approved (block 522) by the business or enterprise app, then the App is configured to provide the customer with the capability to edit the appointment as indicated by the “Edit Appointment” block 528 and an edit process or wizard is started as indicated by reference 530, for example, as described above. According to another aspect, once the booking is approved in block 524, the platform is configured to persist the changes, i.e. save the booking data in memory, as indicated by block 525 in FIG. 5A. The App is configured to determine if the booking includes medical forms or aftercare as indicated by decision block 521. If there is aftercare, then the App is configured to display the aftercare instructions or recommendations, for example, in the form of an “Aftercare Document”, as indicated in block 523. If the booking requires the completion of any form(s), for example, medical form(s), then the App is configured to provide the user with the capability to complete the form(s), for example, as described in more detail with reference to FIG. 23C.

Reference is next made to FIG. 5B, which shows in flowchart form a process or method for booking an appointment utilizing a Business or Administrator App generated or configured according to an embodiment of the present invention. The booking process is indicated generally by reference 540. The booking process 540 is executed by the Business App interfacing to the platform, as described in more detail below, and comprises the following steps.

According to an exemplary implementation, an appointment booking can be initiated from a Calendar (e.g. installed in the Business App), from a Service, or from the main screen or home page of the App, as indicated by decision block 541. The next step involves booking a service as indicated by reference 542. If the service to be booked involves a “Consultation” (for example, as described above), then a determination is made in decision block 543 if the consultation comprises an “In-App” consultation 544 or an “In-Store” consultation 548. If an In-App consultation 544, then the next step in the booking process involves completing the consultation details utilizing the Business App as indicated by reference 546. If, on the other hand, the consultation comprises an In-Store consultation 548, then the availability of In-Store consultations is determined by the platform as indicated by reference 560. According to another aspect, the availability, e.g. available time slots, for In-Store consultations can be edited or revised, for example, by an administrator on the platform, as indicated by reference 551. The availability, i.e. available dates and times, are updated on the Business App, and the admin completes the booking details for the appointment as indicated in block 546. If the service does not require, or offer, a consultation, the Business App is configured to get the availability directly, as indicated by reference 545, from the platform in block 560. The next step in the appointment booking process 540 comprises the Business App requesting a quote for the selected service (and/or consultation) from the platform as indicated by request quote block 562. Next, the Business App is configured to present the administrator (e.g. business owner, manager or employee) with the option of adding more services as indicated by decision block 564. If the administrator wants to add or book any other service(s), then processing moves to the book service block 542 and steps 543 to 562 are repeated as described above. If, on the other hand, the administrator doesn't want to add any more service(s), the Business App transmits a “Book Appointment” notification to the platform as indicated by block 568, and a “Receive Notification is generated at the Customer App as indicated by block 572, and the booking process 540 terminates as indicated by reference 573. As shown, the Business App is configured to provide the capability to edit the appointment as indicated by the “Edit Appointment” block 574 and an edit process or wizard is started as indicated by reference 575, for example, as described above.

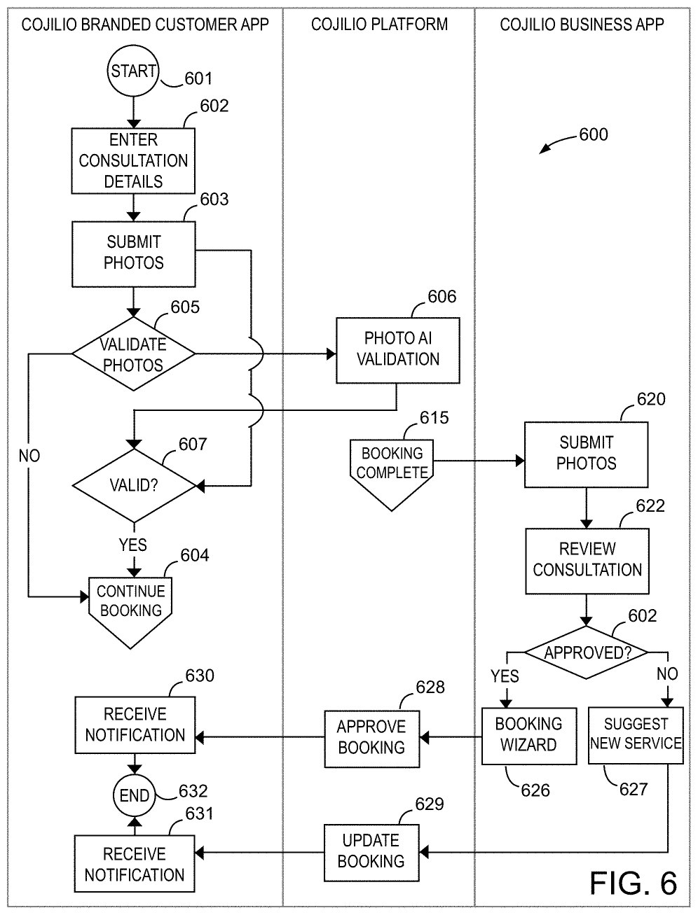

Reference is next made to FIG. 6, which shows in flowchart form a process or method for a digital consultation in accordance with an embodiment of the present invention. The digital consultation process is indicated generally by reference 600. The digital consultation process 600 is executed by the App interfacing to the platform and/or business or enterprise application or app, as described in more detail below. The digital consultation process 600 comprises the following steps.

As shown, the digital consultation process 600 runs on the App as indicated by reference 601. The digital consultation process 600 comprises the customer being prompted to enter the consultation details, and then entering the consultation details as indicated by block 602. The App is configured to then prompt the customer to submit photo(s) as indicated by block 603 in FIG. 6. According to an embodiment, the App is configured to execute a photo validation function as indicated by reference 605, which can be enabled or disabled. If disabled, then the validate photo step 605 is skipped or bypassed as indicated by reference 607, and if the photo(s) are determined to be valid as indicated in decision block 609, then the booking process continues as indicated in step 604. If the photo is determined to be invalid in step 609, then the customer is prompted to resubmit photo(s) in block 603. According to another aspect, the platform is configured with an AI (Artificial Intelligence) based photo validation module as indicated by reference 606. The photo AI validation module 606 is configured to execute AI-based algorithm(s) to analyze and validate the photo(s) and return a valid result or an invalid result for each photo. If the photo(s) are determined to be valid in 609, then the booking process continues as indicated by 604. The customer then continues with booking the appointment on the App (for example, as described above) and indicated by reference 604. Upon completion of the booking as indicated by 616, the platform generates a notification which is received by the business or enterprise app, as indicated in block 620. The consultation request is reviewed at the business app (e.g. for example, by a staff member reviewing customer inputs at the App), as indicated in block 622. If approved, then an Appointment Booking Allowed notification is generated by the business app as indicated in block 626, and the platform sends an Approve Booking notification to the App as indicated by block 628. The App receives the approval notification in block 630 and execution of the digital consultation process ends on the App, as indicated by 632. If the consultation request is not approved (block 624), a new service can be proposed or suggested through the business enterprise app, as indicated in block 627. The platform is configured to update the booking based on the proposed new service, and sends a notification, which is received by the App, as indicated by block 631.

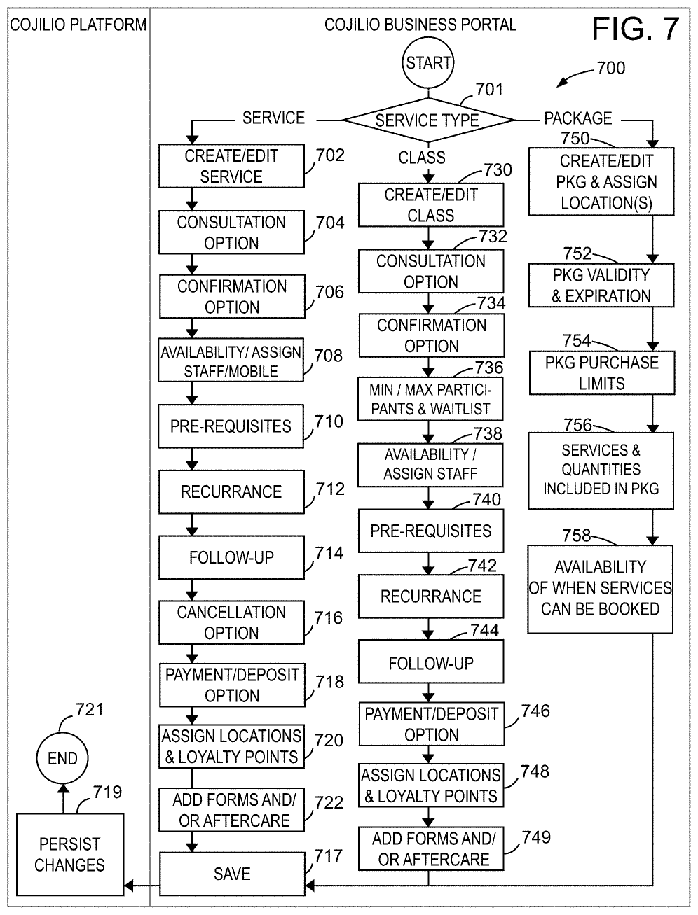

Reference is next made to FIG. 7, which shows in flowchart form a process for customizing a service according to an embodiment of the present invention and indicated generally by reference 700. The customizing a service process 700 is configured to be executed or run primarily on the business portal, and comprises the following steps as described in more detail below.

According to an exemplary embodiment, the customizing a service process 700 is configured to allow a business enterprise to customize a “service”, a “class” and/or a “package”. The first step comprises determining the service type, i.e. a service, a class or a package, as indicted in decision block 701. The first step in customizing a service as indicated by reference 702 comprises creating and/or editing the service, for instance, as described above for the Service Details page 1101 in FIG. 11B. The next step 704 involves determining if the service should include a consultation option, and if yes, then setting the consultation option 1142 in the Service Details page 1101 as described above and depicted in FIGS. 11B, 11C and 113. The next step indicated by reference 706 comprises configuring the service with a confirmation option. The next step in 708 involves configuring the service with an availability setting, for example, a service may not be available at all times and/or all locations associated with a business or enterprise. The next step in 710 involves configuring the services with one or more applicable or required pre-requisites. The next step in 712 comprises configuring the service as a recurring service, if applicable. The next step in 714 involves configuring the service with a follow-up requirement or setting, if applicable. According to another aspect, the customization process 700 provides the capability to add a cancellation option to the service, as indicated in block 716. The next step in block 718 involves configuring a payment and/or deposit option. The customization process 700 also includes the capability for a user to configure the service with assigned location(s) and/or loyalty points, as indicated in block 720. According to another aspect, the customization process 700 provides the capability to add form(s) and/or aftercare as part of the process for booking the service, as indicated in block 722, and for example, as described above with reference to FIG. 12. Once satisfied with the configuration of and/or the settings for the service, the user saves the service configuration in 717, and the business app is configured to generate and/or update the service configuration and save the service as configured to the platform, as indicated in a Persist Changes block 719, which also can also function to update the customer Apps with the service changes or configuration or availability. The customizing process for a service 700 ends as indicated at 721.

Reference is made to FIG. 7, if the service type (as determined in decision block 701) comprises a class, for instance, an exercise class such as a Pilates class, then the first step involves creating and/or editing the class, as indicated in block 730. The next step 732 involves determining if the class should include a consultation option, and if yes, then setting the consultation option. The next step indicated by reference 734 comprises configuring the class with a confirmation option. According to another aspect, the customization process for a class provides the capability set or define the minimum and/or maximum number of participants for the class, and/or the availability of waitlist for the class, as indicated in block 736. The next step in 738 involves configuring the class with an availability setting and/or assigning staff for the class, for example, a class may not be available at all times and/or all locations associated with a business or enterprise, and/or not all staff may be qualified or available to teach or run the class. The next step in block 740 involves configuring the class with one or more applicable or required pre-requisites. The next step in 742 comprises configuring the class as a recurring or repeating class, if applicable. The next step in block 744 involves configuring the class with a follow-up requirement or setting, if applicable. The next step in block 746 involves configuring a payment and/or deposit option for booking or taking the class. The customization process 700 also includes the capability for a user to configure the class offering with assigned location(s) and/or loyalty points, as indicated in block 748. According to another aspect, the customization process 700 provides the capability to add form(s) and/or aftercare as part of the process for booking the class, for example, consent or disclaimer forms, as indicated in block 749. Once satisfied with the configuration of and/or the settings for the class, the user saves the class configuration in 717, and the business app is configured to generate and/or update the class configuration and save the class as configured to the platform, as indicated in a Persist Changes block 719, which also can also function to update the customer Apps with the class changes, availability or configuration. The customizing process for a class 700 ends as indicated at 721.

Reference is again made to FIG. 7, if the service type (as determined in decision block 701) comprises a package, for instance, a package or bundle of services, then the first step involves creating and/or editing the package, and/or assigning location(s) where the package is available, as indicated in block 750. The next step in block 752 involves setting the package validity and/or any expiration date for the package. The next step indicated by reference 754 comprises setting any package limits, for example, number of packages that can be purchased by a customer at one time, or over a period of time. The next step indicated by reference 756 involves configuring the services (or classes) and/or quantities of particular services (or classes) to be included in the package. The customization process for a package may also include the capability to define the availability for a package, for instance, when the services (or classes) in the package can be booked, as indicated in block 758. Once satisfied with the configuration of and/or the settings for the package, the user saves the package configuration in 717, and the business app is configured to generate and/or update the package configuration and save the package as configured to the platform, as indicated in a Persist Changes block 719, which also can also function to update the customer Apps with the package changes, configuration or availability. The customizing process for a class 700 ends as indicated at 721.

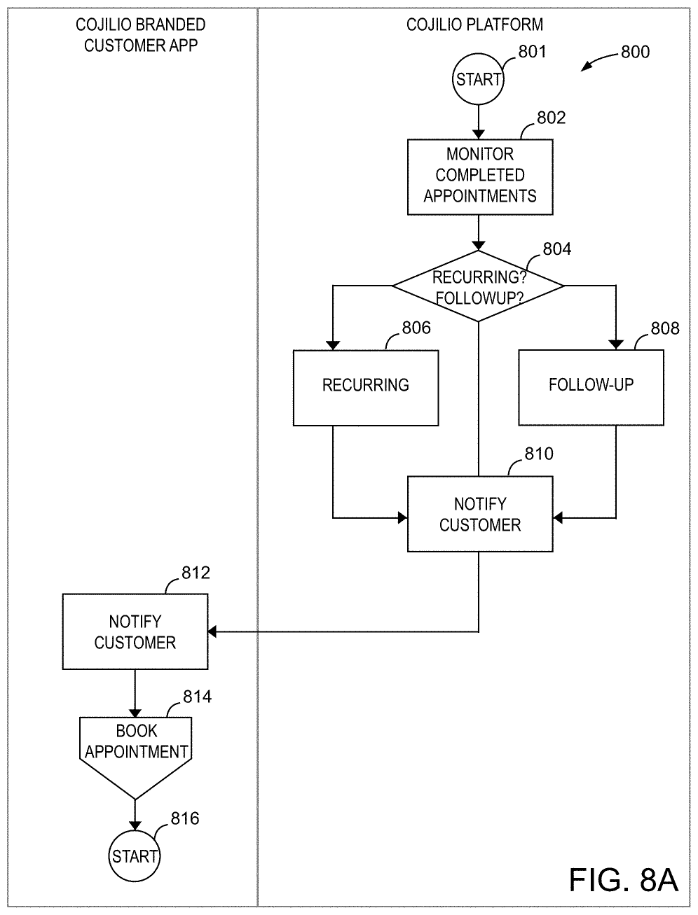

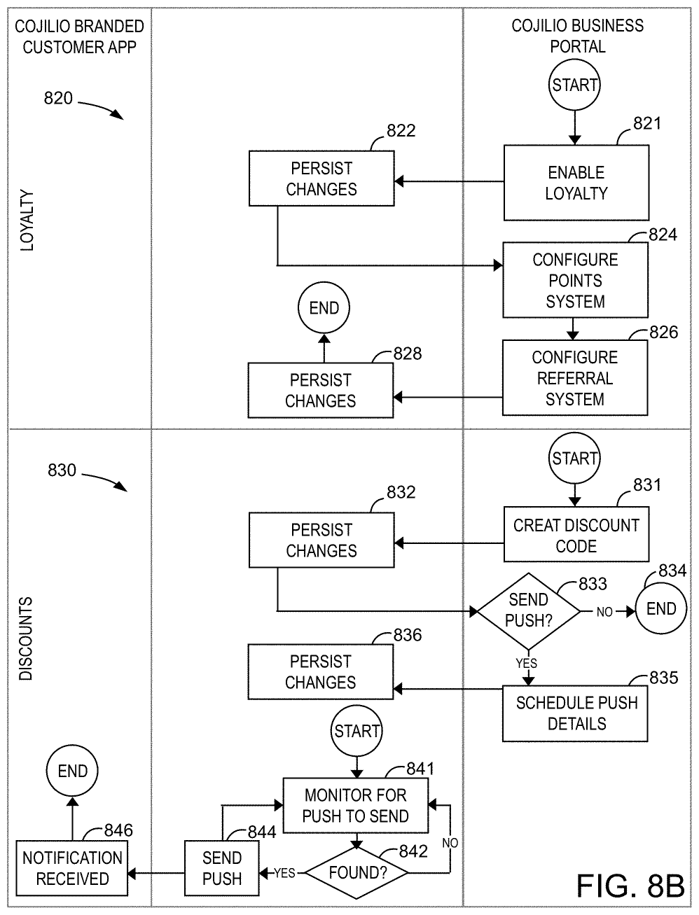

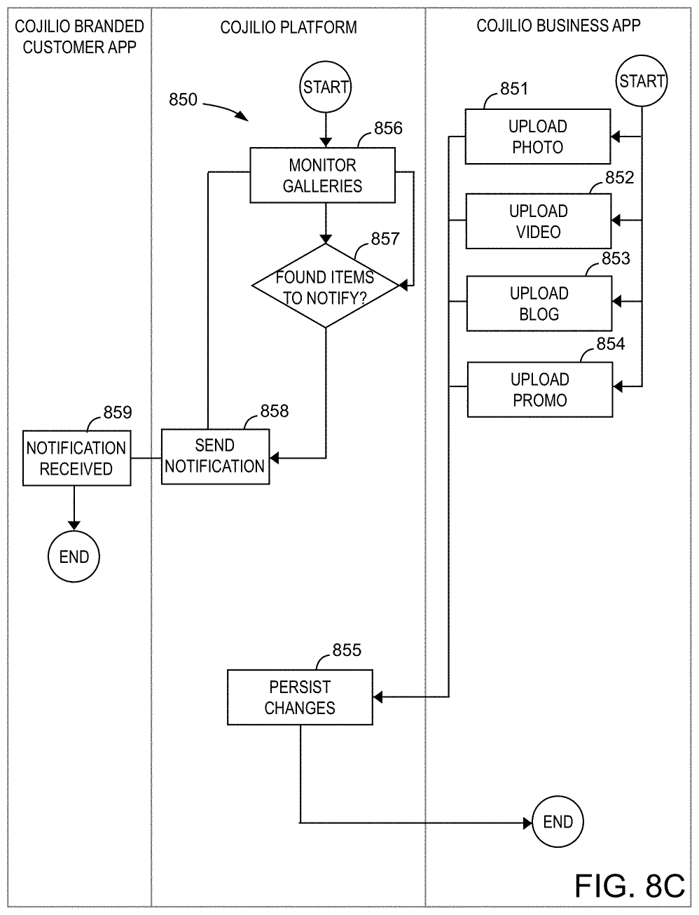

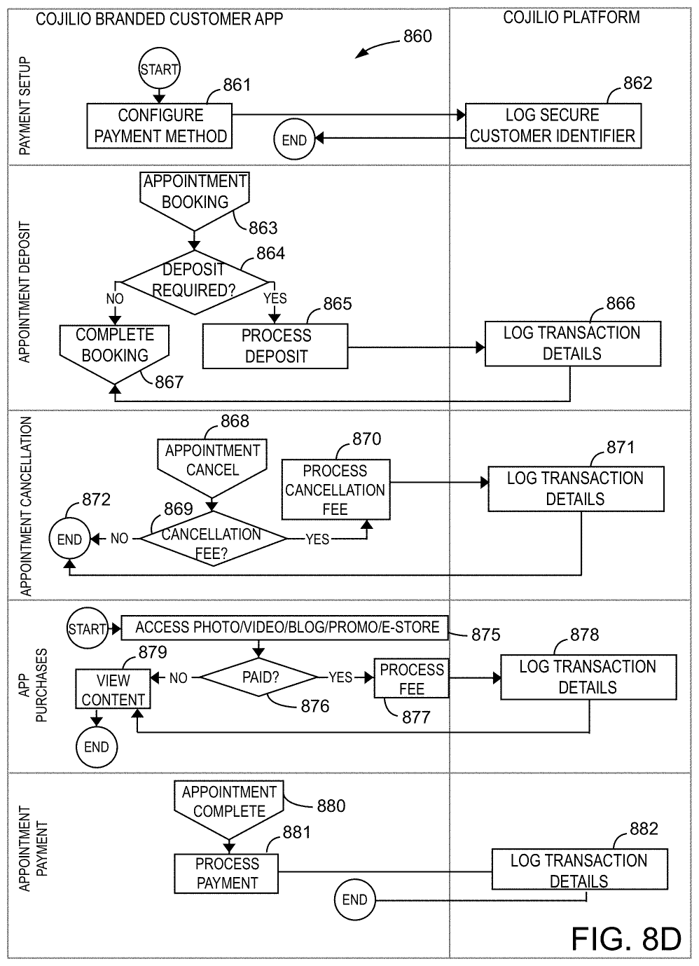

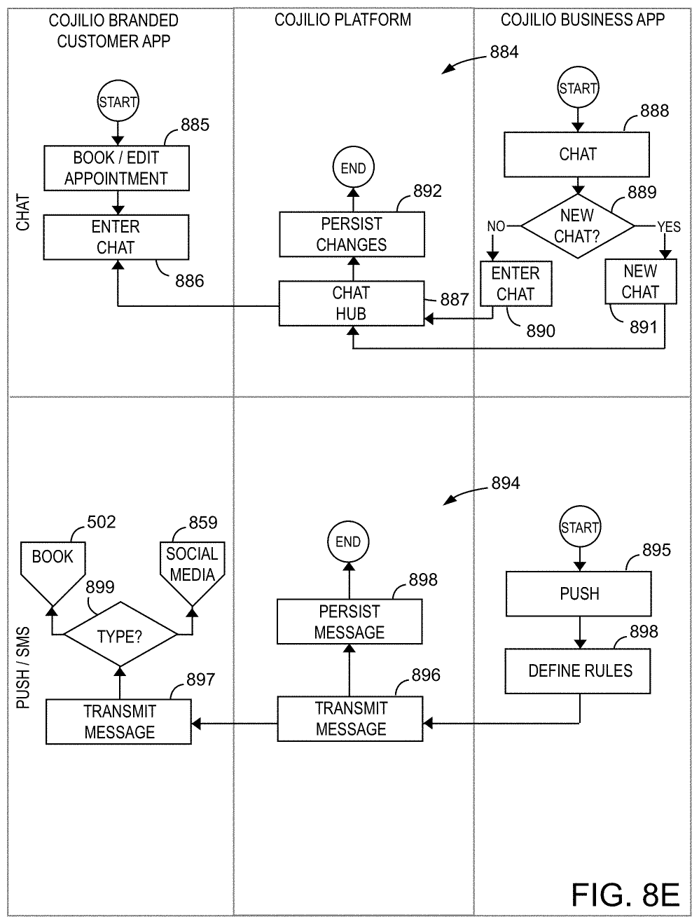

Reference Is next made to FIG. 8A, which shows in flowchart form a process or method for refill/follow-up/recurring smart tracking according to an embodiment of the present invention. The refill/follow-up/recurring smart tracking process is indicated generally by reference 800. The refill/follow-up/recurring smart tracking process 800 is executed primarily on the platform which interfaces to the App, as described in more detail below, and comprises the following steps.

The refill/follow-up/recurring smart tracking process 800 begins executing on the platform as indicated by 801, and the first step comprises monitoring completed appointments as indicated in block 802. The smart tracking process 800 determines in decision block 804 if an appointment is recurring or requires a follow-up. If the appointment is “recurring” as indicated by block 806, then a customer notification is generated in block 810, and the notification is transmitted to and received by the App installed on the customer devices, e.g. smart phones, as indicated in block 812. If the appointment requires a follow-up as indicated in block 808, then the platform generates a customer notification in block 810, which is transmitted to the customer App and received the customer's smart phone in 812. Through the App, the customer books the appointment (e.g. recurring appointment or a follow-up appointment) as indicated in 814, and once the booking is completed, the App ends execution.

Reference is next made to FIG. 8B, which shows in flowchart form a process or computer-implemented method for a loyalty and a discounts function or process according to an embodiment of the present invention. The loyalty function indicated generally by reference 820 according to an embodiment is configured to execute through the business portal for the system. The loyalty function 820 comprises an enable loyalty input or control indicated by reference 821 and the enabling (or disabling) operation is saved on the platform as indicated by a Persist Change block 822. According to another aspect, the loyalty function 820 comprises a configure points function and/or a configure referral system function as indicated by references 824 and 826. These functions are implemented to allow a user to configure a loyalty points system or scheme and/or a loyalty referral system or scheme, which is then saved to the platform as indicated by a Persist Changes block or operation 828.

The discounts function 830 is configured to allow a user to create discount codes (e.g. digital coupons) for an enterprise, and according to an embodiment is configured to also execute or operate through the business portal of the system as shown in FIG. 8B. The discounts process comprises a create discount code function or operation indicated by reference 831 which is configured to allow a user to create a discount code(s) which are saved on the platform in a Persist Changes block or operation indicated by reference 832. According to another aspect, the loyalty function 830 is configured to provide the capability to “push” the discount code (created in block 831) as determined in decision block 833 down to the customer App, as described in more detail below with reference to Notification Received block 846. If the user does not want to push the discount code (as determined in decision block 833), the discounts function or process ends as indicated by reference 834. If the user decides to “push” the discount code, then the discounts function 830 is configured to allow the user to schedule the push details as indicated by reference 835, and the push details are saved to the platform in a Persist Changes block or operation as indicated by reference 836.

As shown in FIG. 8B, the discount process 830 is configured on the platform to monitor for “push to send” notifications or operation as indicated by reference 841 on a continuous or intermittent basis, and if found in decision block 842, the discount notification is pushed down to the customer App as indicated by block 844. The pushed notification is received by the customer App as indicated by the Notification Received block 846. The customer App may be further configured to provide a notification to the customer of the receipt or existence of a discount code, for example, on their mobile device.

FIG. 8C shows in flowchart form a social media channel process or function according to an embodiment of the present invention and indicated generally by reference 850. According to one aspect, the social media channel 850 is configured to execute on the business App and provide a user with the capability to upload photo(s) 851, upload video(s) 852, upload a blog 853 and upload promotional media 854. The media uploaded through the business App is then saved to the platform as indicated by the Persist Changes block 855.

As also shown in FIG. 8C, the platform is configured to monitor for changes in the social media galleries as indicated by a Monitor Galleries operation 856. If new media or uploads are found as determined in decision block 857, then a send notification is generated as indicated by a Send Notification operation 858 which is pushed or downloaded to the customer App(s). The customer App is configured to receive the social media notification as indicated by a Notification Received block 859. The customer App may be further configured to provide a notification to the customer of the receipt or existence of a social media update or notification, for example, on their mobile device.

FIG. 8D shows in flowchart form an eCommerce and payments function or process indicated generally by reference 860. According to an embodiment of the present invention, the eCommerce and Payments function comprises a payment setup function, an appointment deposit function, an appointment cancellation function, an App purchases function and appointment payment function.

As shown in FIG. 8D, the payment setup function is initiated or invoked on the customer App and comprises the user, i.e. the customer, configuring a (preferred) payment method as indicated by reference 861. The platform is configured to secure and log the customer's payment method as indicated by reference 862.

As shown in FIG. 8D, the appointment deposit function is configured (when enabled for particular service(s)) to process a deposit if the booking of an appointment requires a deposit. As shown, the appointment deposit function is initiated by an appointment booking as indicated by reference 863. If a deposit is required as determined in decision block 864, the appointment deposit function is configured to process a deposit from the user through the customer App as indicated by the reference 865. The transaction details of the processed deposit are logged and saved on the platform as indicated by reference 866, and the appointment booking is completed as indicated by reference 867. If a deposit is not required (as determined in decision block 864), then the appointment booking is completed as indicated by reference 867 without any further deposit processing.

As shown in FIG. 8D, the appointment cancellation function is configured (when enabled for particular service(s)) to process or charge a cancellation fee for a cancelled or missed appointment. As shown, the appointment cancellation function is initiated by an appointment cancellation as indicated by reference 868. If a cancellation fee is payable or required as determined in decision block 869, then the appointment cancellation function is configured to charge a cancellation fee to the customer through the customer App as indicated by the reference 870. The transaction details of the cancellation fee are logged and saved on the platform as indicated by reference 871, and the appointment cancellation fee function ends as indicated by reference 872. If, on the other hand, a cancellation fee is not payable or not enabled, then the appointment cancellation fee function terminates as indicated by reference 872 in FIG. 8D, without any cancellation fee being charged to the customer.

As shown in FIG. 8D, the App purchases function is configured to allow a customer to make purchases through the customer App. According to an embodiment, the purchases comprise content available through one or more of the social media channels, i.e. photo, video, blog and/or promotions, as indicated by reference 875. The content may comprise paid content or free content as determined in decision block 876. If paid content, then the customer App is configured to process a fee or payment from the customer, for example, a subscription fee, as indicated by reference 877 in FIG. 8D. The transaction details of the purchase fee are logged and saved on the platform as indicated by reference 878, and the customer is then able to view the purchased or paid for content on the customer App on their mobile device as indicated by reference 879. On the other hand, if the content is free, or with no fee payable, then the customer App is configured to allow the customer to view the content without any fee or payment processing as indicated by reference 879.

As shown in FIG. 8D, the appointment payment function is configured to process an appointment payment when an appointment is completed. As shown, the appointment payment function is initiated by the completion of an appointment as indicated by reference 880. The payment is processed, for example, through the customer's preferred payment method (block 861) in the customer App as indicated by reference 881. The transaction details of the payment are logged and saved on the platform as indicated by reference 882, and the payment function ends.

FIG. 8E shows in flowchart form a chat function and a push function or process according to an embodiment of the present invention. The chat function is indicated generally by reference 884 and is configured to provide a chat function or facility between a customer utilizing the customer App and a user utilizing the business App. According to an exemplary implementation, the chat function 884 is initiated by a customer booking (or editing) an appointment as indicated by reference 885. The customer App is configured to prompt or invite the customer to enter a chat as indicated by reference 886. The platform comprises a chat hub 887 which is configured to establish a chat between the customer and the business App associated with the business or enterprise, as shown in FIG. 8E. The business App comprises a chat function or module 888 which is configured to determine if the chat is a new chat in decision block 889. If the chat is an existing chat, then the business App is configured to enter the chat with the customer as indicated by reference 890. On the other hand, if the chat is a new chat, then the business App is configured to start a new chat as indicated by reference 891. According to another aspect, the platform can be configured to save or persist the messages or content for one or more chats, as indicated by reference 892.

Reference is again made to FIG. 8E, which shows a push function for pushing messages, e.g. SMS and Push messages, from the business App to the customer App. The business App is configured with a functional module for composing and pushing messages to the platform as indicated by reference 895. The customer is able to define rules for the push, etc., as indicated in block 898. The platform is configured to transmit the message to the customer App as indicated by reference 896. The platform may also be configured with a persist message module 898 for saving or archiving the message(s). The customer App receives the message from the platform as indicated by reference 897, which is then made available to the customer. Depending on the type of message as indicated in block 899, the App directs the customer to a screen that is configured to allow a service booking as indicated by reference 502 (see also FIG. 5A), or to a link to social media as indicated by reference 859 (see also FIG. 8C).

Reference is next made to FIG. 23A, which shows a purchase package process or method executable by the customer App according to an embodiment of the present invention and indicated generally by reference 2300. As shown in FIG. 23A, the purchase package process 2300 begins with the customer selecting a package as indicated in decision block 2301. The next step as indicated by decision block 2302 comprises determining if the package is available. If yes, the customer purchases the package as indicated in block 2304. The purchase of the package and payment is confirmed as indicated in block 2306, and execution of the purchase process 2300 ends or terminates.

Reference is next made to FIG. 23B, which shows a process or method for booking a class using the customer App according to an embodiment and indicated generally by reference 2340. The book a class process 2340 begins with the customer selecting a class as indicated in decision block 2341. The next step involves the App displaying the details comprising the class information, including availability, as indicated in block 2342. The next step as indicated by decision block 2344 comprises determining if the class is available. If yes, the customer books the class as indicated in block 2346. If payment is required for the class as determined in decision block 2348, then the customer App is configured to prompt the customer to confirm the booking and make the required payment in block 2350, and the payment is processed by the platform. The class is booked and confirmed as indicated in block 2352. If payment is not required as determined in step 2348, then the class is booked and confirmed in block 2352, and execution of the book a class process 2340 ends or terminates. If the class is not available, there may be availability on a waitlist. If the App determines the availability of a spot or opening on a waitlist as indicated in block 2353, then the customer is prompted to add their name or input on the waitlist as indicated in block 2354, and processing in the book a class process ends.

Reference is next made to FIG. 23C, which shows a customer forms process or method according to an embodiment of the present invention and indicated generally by reference 2320. The customer forms process Is executed by the customer App to provide the customer with any form(s) required for a service and collect and validate the customer entered data in those form(s) as described in more detail below.

According to an embodiment, the customer forms process 2320 starts execution after an appointment is confirmed as indicated in block 2321, and includes a decision logic block 2322 to determine if a form is required for the selected appointment/service. If a form is not required, the process 2320 ends as indicated by reference 2323. On the other hand, if form(s) are required, then the required form is generated and presented in electronic form on the customer App and the customer is prompted to enter the required data specified in the form, as indicated in block 2324. The user, i.e. customer, fills in the content as requested by the form, in block 2326, and the customer forms process 2320 validates the user entered data in block 2328, and the validation/data entry is repeated until the required data is entered and validated. Once all the required data has been entered and validated in step 2328, the electronic form is submitted as indicated in block 2330. The electronic form data is saved to the platform in a Persist Changes block 2332. The electronic form and data is also made available for viewing in the business App as indicated by block 2334 in FIG. 23C. The customer forms process 2320 ends as indicated by reference 2336.

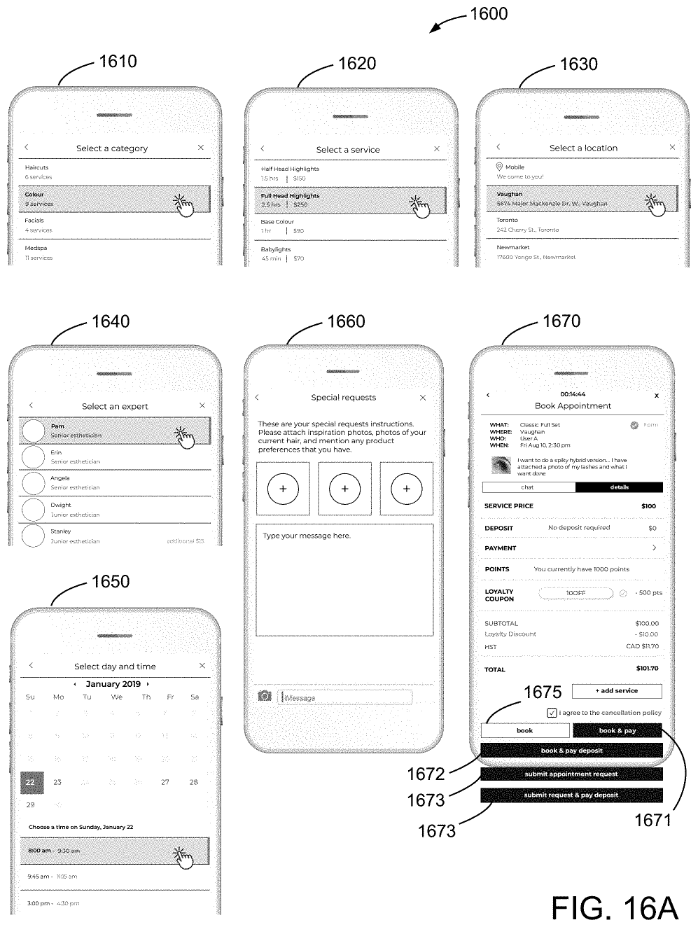

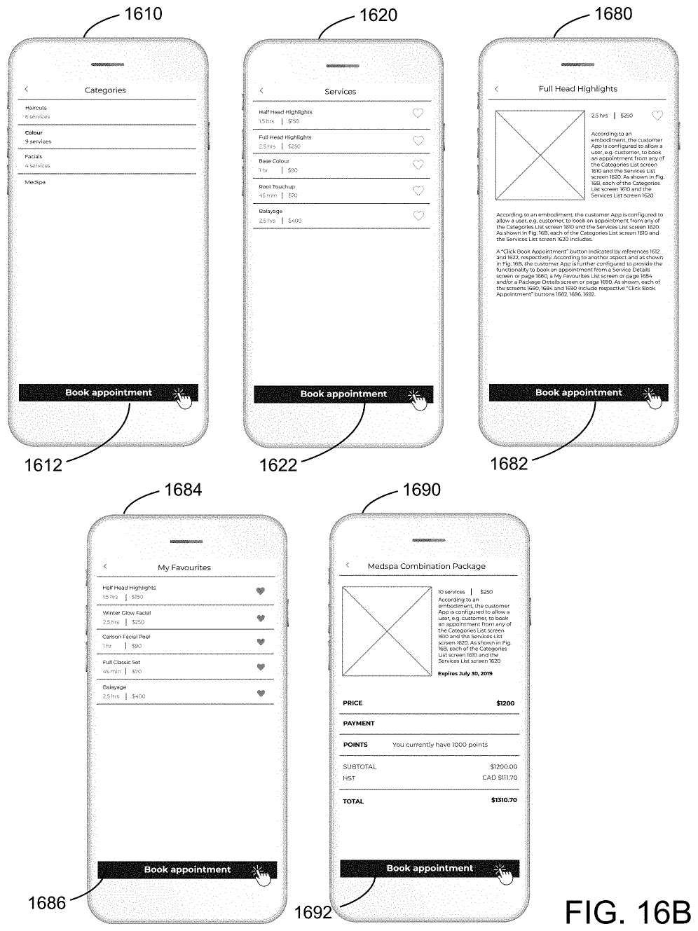

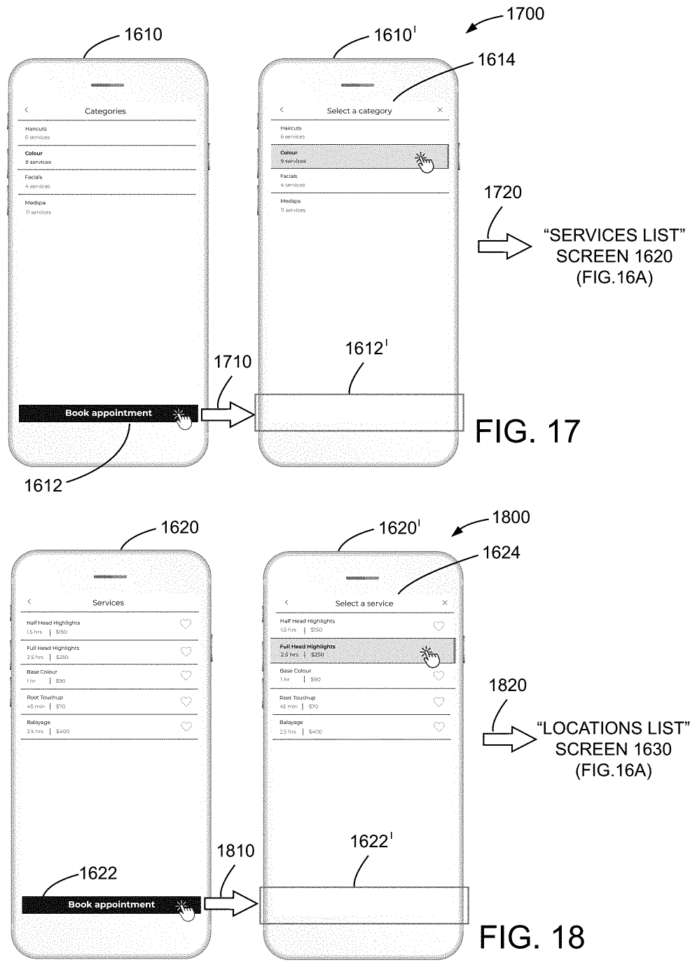

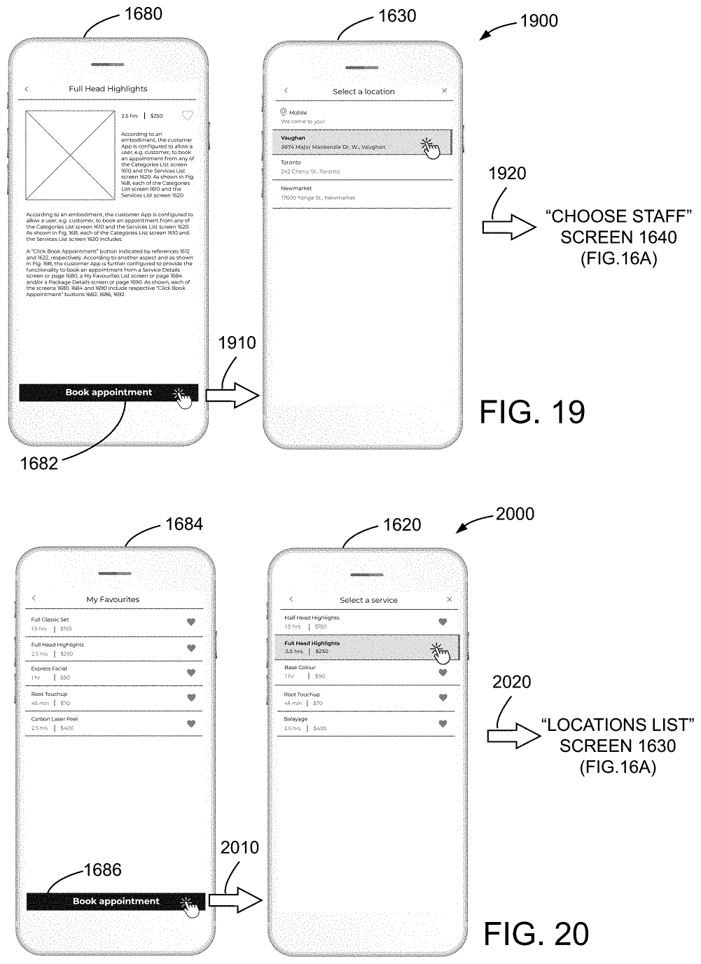

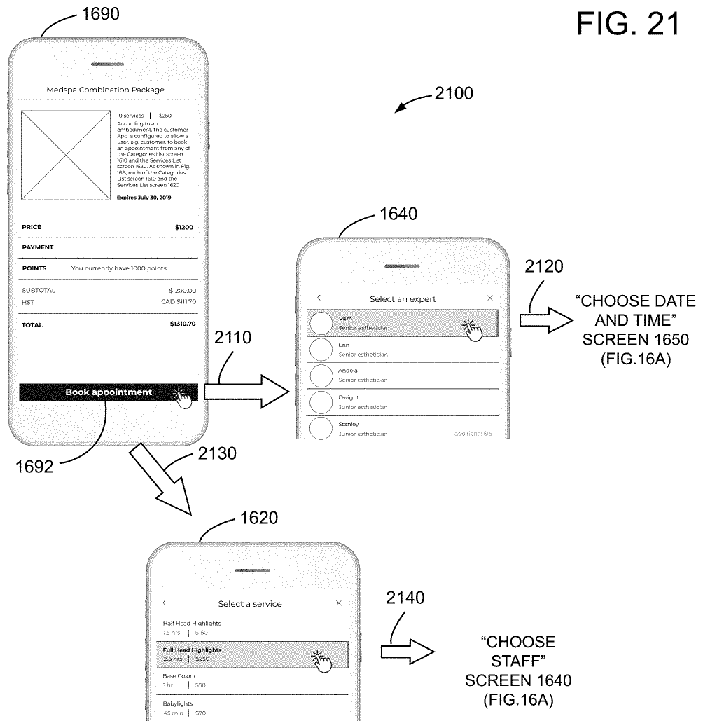

Reference is next made to FIG. 16A which shows screen shots of a book appointment wizard according to an embodiment of the present invention and indicated generally by reference 1600. The book appointment wizard 1600 comprises a Categories page or screen 1610, a Services List page or screen 1620, a Locations List page or screen 1630, a Choose Staff page or screen 1640, a Choose Date, then Time page or screen 1650, a Special Requests page or screen 1660, and a Booking Summary page or screen 1670.

According to an embodiment, the Categories page 1610 comprises a list of categories of services available from a business or enterprise. According to an exemplary implementation, the business comprises a beauty salon and service categories comprise: “Haircuts”, “Colour” and “Facials” as shown in FIG. 16A. In response to the customer clicking (i.e. “tapping”) the Colour service field, the customer App is configured to display the Services List page 1620. As shown in FIG. 16B, the Services List page 1622 is configured to display the individual or associated services for the Colour category service comprising, for instance, “Half Head Highlights” service, “Full Head Highlights” service, “Base Colour” service, “Babylights” service, “Root Touchup” service and “Balayage” service. In response to the customer selecting one of the services, in this example, the “Full Head Highlights” service, the customer App is configured to display the Locations List screen or page 1630 if there are multiple locations, or if the service is available at multiple locations. If only location is available, the customer App does not display the Locations List screen 1630. In this example, the selected service is available a “Toronto” location, a “Vaughan” location, and a “Markham” location, and the customer selects the “Vaughan” location. In response, the customer App is configured to display the Choose Staff screen 1640 if there are multiple staff at the selected location or the service is assigned to multiple staff. If only one staff member is available for performing the selected service, then the customer App is configured not to display the Choose Staff screen 1640 and the customer App displays the Choose Date, then Time screen 1650. As shown in FIG. 16A, the Choose Date, then Time screen 1650 is configured to allow a user, e.g. a customer, to select an available date for receiving the service, for example, Sunday, April 22; Monday, April 23; Friday, April 27 or Saturday, April 28. In this instance, the customer selects Sunday, April 22 for the booking the service, and the customer App is configured to display a list of times the service can be booked. The customer selects 9:45 am-11:30 am. If configured for the service, then the customer is permitted to enter special requests, as indicated by reference 1660 (see also FIG. 16A).

As shown in FIG. 16A, the Booking Summary page 1670 is configured with an Edit facility which allows a user, e.g. a customer, to edit the service and/or associated attributes. According to an embodiment, the Edit function comprises an Edit Service function, an Edit Location function, an Edit Staff function, and an Edit Day & Time function. The Edit Service function is configured with service name field that is responsive to a user input, e.g. a click, to display the Selects List screen 1620 and allow the user to select a new service for booking, followed by the Locations List screen 1630, the Choose Staff screen 1640, the Choose Date, then Time screen 1650, the Special Requests screen 1660, and then the Booking Summary screen 1670. The Edit Location function is configured with a location field that is responsive to a customer input or click to display the Locations List screen 1630 for selecting a new location, and then followed by the Choose Staff screen 1640, the Choose Date, then Time screen 1650, the Special Requests screen 1660, and the Booking Summary screen 1670. If the service is only available at a single location, then the location field is not enabled. The Edit Staff function is configured with a staff name field that is responsive to a customer input or click to display the Choose Staff screen 1640 for selecting a new member of staff for performing the service, and then followed by the Choose Date, then Time screen 1650, the Special Requests screen 1660, and then the Booking Summary screen 1670. The Edit Day & Time function is configured with a day and time field that is responsive to a customer input or click to display the Choose Date, then Time screen 1650, followed by the Special Requests screen 1660, and then the Booking Summary screen 1670. According to another aspect, the customer App is configured to provide multiple booking options (according to the particular configuration of the service, for example, as described in more detail with references 1671, 1672, 1673, 1674 and 1675.

According to an embodiment, the customer App is configured to allow a user, e.g. customer, to book an appointment from any of the Categories List screen 1610 and the Services List screen 1620. As shown in FIG. 16B, each of the Categories List screen 1610 and the Services List screen 1620 includes a “Book Appointment” button indicated by references 1612 and 1622, respectively. According to another aspect and as shown in FIG. 16B, the customer App is further configured to provide the functionality to book an appointment from a Service Details screen or page 1680, a My Favourites List screen or page 1684 and/or a Package Details screen or page 1690. As shown, each of the screens 1680, 1684 and 1690 include respective “Book Appointment” buttons 1682, 1686, 1692.

Reference is next made to FIG. 17, which shows a book appointment process or sequence from the Categories screen 1610 according to an exemplary implementation and indicated generally by reference 1700. To initiate the booking of an appointment, the customer clicks the Book Appointment button 1612 on the Categories screen or page 1610. In response and as indicated by reference 1710, the customer App generates an updated Categories screen 1610′ without the Book Appointment button indicated by reference 1612′ and changes the “Categories” title to “Choose a category” title as indicated by reference 1614. In response to the customer choosing, i.e. clicking or tapping, one of service categories, in this example, the “Colour” service category, the book appointment process 1700 proceeds to display the Services List screen 1620 (as described above with reference to FIG. 16A) as indicated by reference 1720 in FIG. 17 and the book appointment wizard or sequence is executed as described above with reference to FIG. 16A.

Reference is next made to FIG. 18, which shows a book appointment process or sequence from the Services List page or screen 1620 according to an exemplary implementation and indicated generally by reference 1800. To initiate the booking of an appointment, the customer clicks the Book Appointment button 1622 on the Services List page 1620. In response and as indicated by reference 1810, the customer App generates an updated Services List screen 1620′ without the Book Appointment button indicated by reference and changes the “Services” title to “Select a service” title as indicated by reference 1624. In response to the customer choosing one of service categories, in this example, the “Full Head Highlights” service, the book appointment process 1800 proceeds to display the Location List screen 1630 (as described above with reference to FIG. 16A) as indicated by reference 1820 in FIG. 18 and the book appointment wizard or sequence is executed as described above with reference to FIG. 16A.

Reference is next made to FIG. 19, which shows a book appointment process or sequence from the Service Details screen 1680 (FIG. 16B) according to an exemplary implementation and indicated generally by reference 1900. The Service Details screen 1680 is configured to show specific details and/or additional information about a service being offered by the business enterprise. To initiate the booking of an appointment, the customer clicks the Book Appointment button 1682 on the Service Details screen or page 1680. In response and as indicated by reference 1910, the customer App displays the Locations List screen 1630 and in response to the customer choosing a location, in this example, the city of “Vaughan”, the book appointment process 1900 proceeds to display the Choose Staff page 1640 (as described above with reference to FIG. 16A) as indicated by reference 1920 in FIG. 19, and the book appointment wizard or sequence is executed as described above with reference to FIG. 16A.

Reference is next made to FIG. 20, which shows a book appointment process or sequence from the My Favourites List page or screen 1684 (FIG. 16A) according to an exemplary implementation and indicated generally by reference 2000. The My Favourites page 1684 is configured to list the ‘favourite’ services of the customer. To initiate the booking of an appointment, the customer clicks the Book Appointment button 1686 on the My Favourites page 1684. In response and as indicated by reference 1910, the customer App displays the Services List screen 1620 and in response to the customer choosing a service, in this example, “Root Touchup”, the book appointment process 2000 proceeds to display the Location List page 1630 (as described above with reference to FIG. 16A) as indicated by reference 2020 in FIG. 20, and the book appointment wizard or sequence is executed as described above with reference to FIG. 16A.

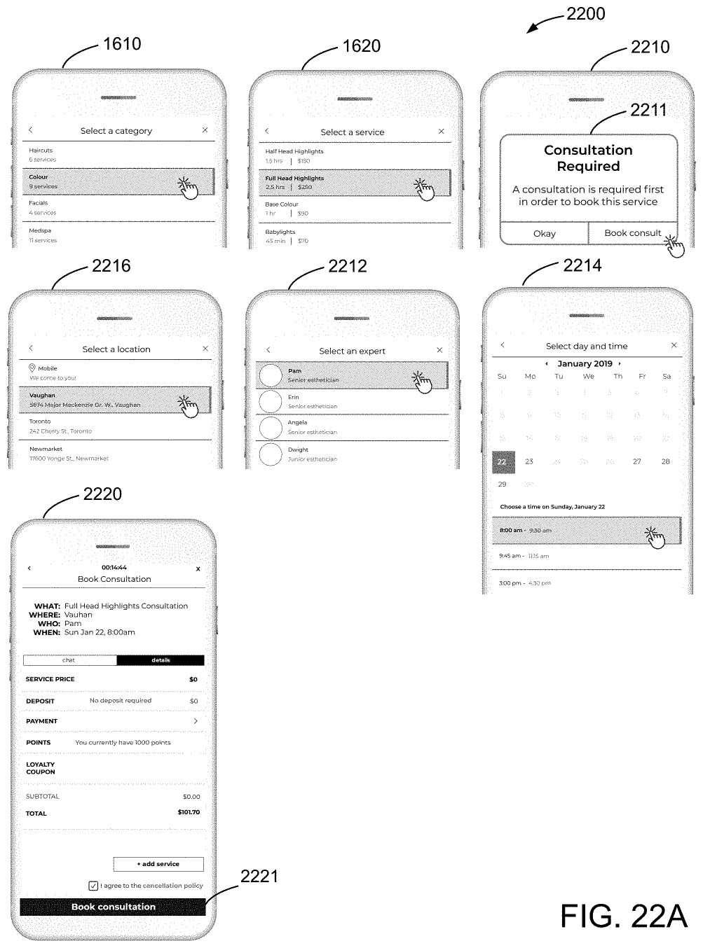

Reference is next made to FIG. 21, which shows a book appointment process or sequence initiated from the Package Details screen or page 1690 (FIG. 16B) according to an exemplary implementation and indicated generally by reference 2100. The Package Details screen or page 1690 is configured to show the details of services which are being offered as part of a package or a promotion or the like. In this example, the “package” comprises a “Chemical Peel Package” with an expiry of Jul. 30, 2019. The Package Details screen 1690 is also configured to show the “Price”, “Deposit”, “Payment” method, “Total” owing, and the “Book Appointment” button 1692. If the package comprises all the same service, the customer App is configured to proceed to the Choose Staff screen 1640 as indicated by reference 2110 in FIG. 21. In response to the customer selecting a staff member or “expert”, in this example, “Stephanie”, the book appointment from package details process 2100 proceeds to display the Choose Date, then Time page 1650 (as described above with reference to FIG. 16A) as indicated by reference 2120 in FIG. 21, and the book appointment wizard or sequence is executed as described above with reference to FIG. 16A.

Referring still to FIG. 21, if the package comprises different services, then the book appointment from package details process 2100 is configured to display the Services List page 1620 in the customer App as shown in FIG. 21. In response to the customer choosing a service, in this example, “Full Head Highlights”, the book appointment from package details process 2100 proceeds to display the Choose Staff page 1640 (as described above with reference to FIG. 16A) as indicated by reference 2140 in FIG. 21, and the book appointment wizard or sequence is executed as described above with reference to FIG. 16A.

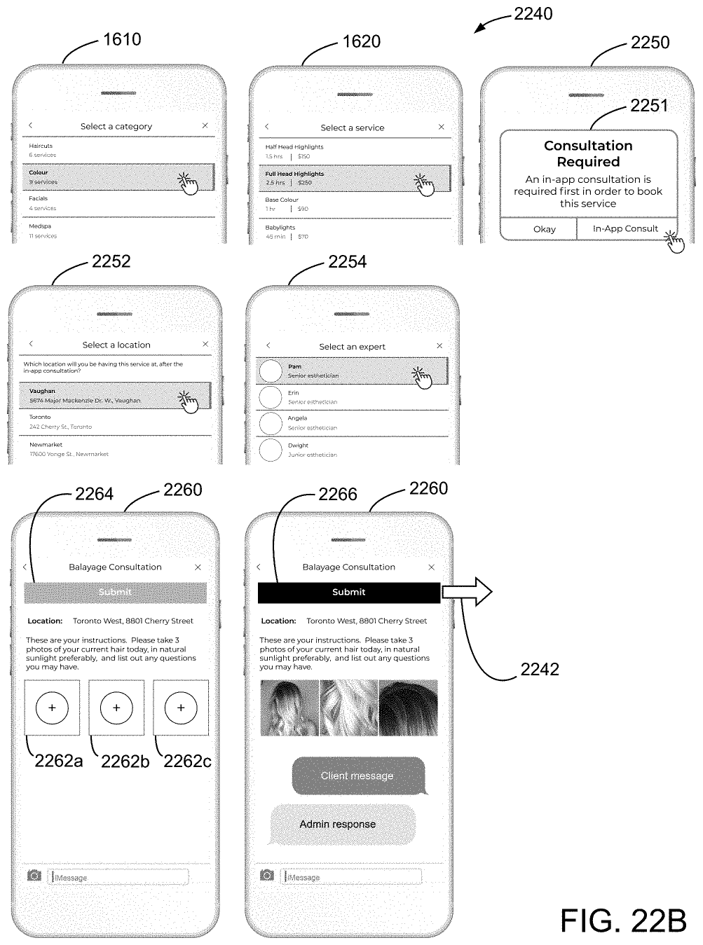

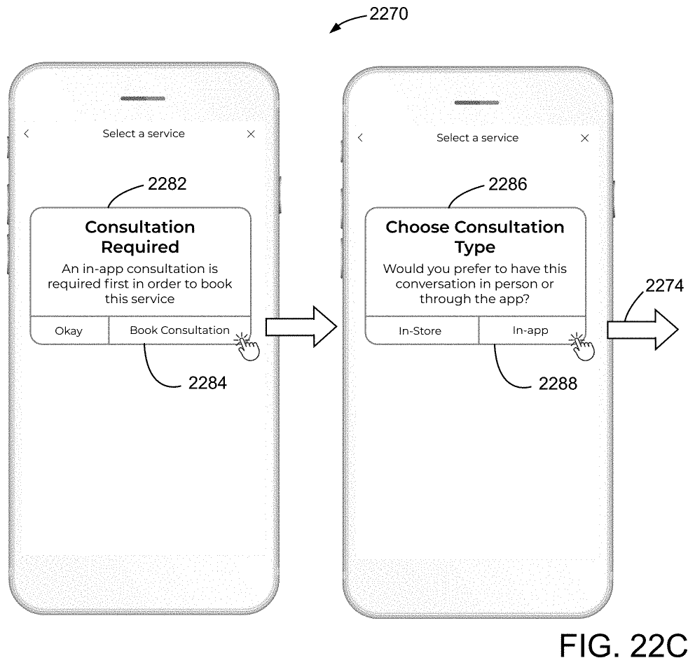

Reference is next made to FIG. 22A, which shows an In-Store Consult process or sequence according to another aspect of the present invention and indicated generally by reference 2200. As described above, the customer App is configured to allow a customer to select a service category from the Service Categories page or screen 1610, and in response to the customer selecting one of the service categories, the Services List page or screen 1620 is displayed or invoked as shown in FIG. 22A. In this example, the customer selects “Full Head Highlights” from the Services List page 1620, which requires an in-store consultation. In response to selection of the service, the customer App is configured to display an In-Store Consultation screen or page 2210 as shown in FIG. 22A. The In-Store Consultation page 2210 is configured to require the customer to book a consultation in order to continue with the booking of the service, and includes a “book consultation” button 2211. In response, the customer App displays an In-Store Consultation Choose Staff page or screen as indicated by reference 2212. The In-Store Consultation Choose Staff page 2212 is configured to allow the customer to select one of the staff for the in-store consultation. According to another aspect, the In-Store Consultation Choose Staff page 2212 has the same “look and feel” of the Choose Staff page 1640 (FIG. 16A). In response to the customer choosing a staff member, e.g. “Stephanie”, the customer App displays an In-Store Consultation Choose Date, then Time page or screen 2214, which has the same “look and feel” of the Choose Date, then Time screen 1650 (FIG. 16A) and is configured to allow the customer to book the date and time for the in-store consultation. Once the customer completes the scheduling of the in-store consultation, the In-Store Consult process 2200 displays a Consultation Summary screen or page as shown in FIG. 22A and indicated by reference 2220. The Consultation Summary page 2220 also has a similar “look and feel” to the Booking Summary screen 1670 (FIG. 16A), but doesn't include the capability to add a service. The Consultation Summary page 2220 summarizes the particulars of the in-store consultation appointment, e.g. “What”, “Where”, “Who” and “When” and further includes “Price”, “Deposit”, “Payment”, “Total” details and checkbox for accepting the cancellation policy. The customer completes the in-store consultation booking by clicking a “book” button as shown and indicated by reference 2221 in FIG. 22A. If the in-store consultation requires payment of a consultation fee, then the book button 2221 is replaced with a “book & pay” button similar the “book & pay” button 1671 in the Booking Summary screen 1670 (FIG. 16A).

Reference is next made to FIG. 22B, which shows an In-App Consult process or sequence according to another aspect of the present invention and indicated generally by reference 2240. If the service selected by a customer requires a consultation and the consultation can be made through the customer App, then the customer App is configured to generate and display an In-App Consult page or screen as shown in FIG. 22B and indicated by reference 2250. As shown, the In-App Consult page 2250 comprises a notification indicating that an “in-app consultation” is required first in order to book the selected service. The customer taps or clicks an “in-app consult” button 2251 to continue. If the selected service is available at multiple locations, then the customer App is configured to generate and display an In-App Locations List screen or page as indicated by reference 2252. According to an exemplary implementation the In-App Consult Locations List page 2252 has the same “look and feel” of the Locations List page 1630 (FIG. 16A). If the selected service is only available at a single location, or the business enterprise only has one location, then this step is skipped in the In-App Consult process 2240. In this example, there are multiple locations, and the customer selects the “Vaughan” location. If the selected service is assigned to more than one staff member, or there are multiple staff members who perform the service, then the In-App Consult process 2240 is configured to generate and display an In-App Consult Choose Staff page or screen as shown in FIG. 22B and indicated by reference 2254. According to an exemplary implementation the In-App Consult Choose Staff page 2254 has the same “look and feel” of the Choose staff page 1640 (FIG. 16A). If the selected service is only assigned to a single staff member, or there is only a single staff member available, then this step is skipped in the In-App Consult process 2240. In this example, there are multiple staff members, and the customer selects “Stephanie” in the In-App Consult Choose Staff list page 2254. The In-App Consult process 2240 is configured to generate and display an In-App Consultation page having a form as shown in FIG. 22B and indicated by reference 2260. In this example, the In-App Consultation page 2260 is configured for a “Balayage Consultation” and requires the customer to take and submit three photos to three photo upload windows 2262a, 2262b, 2262c and click or tap a “submit” button 2264. Once the required photos are uploaded, the In-App Consultation page 2260 is refreshed. The In-App Consultation page 2260 may also include a chat function as shown and indicated by reference 2268, for example, if additional information or photos are required for the in-app consultation. Once the in-app consultation is approved by the administrator, the In-App Consult process 2240 is configured to a “book appointment” button 2266 as shown on the In-App Consultation page 2260, and the customer proceeds to book the appointment through the customer App in a manner as described above.

Reference is next made to FIG. 22C, which shows an embodiment comprising a service where both an in-store consultation and an in-app consultation are available as indicated by reference 2270. The customer App is configured to generate and display a Consultation Required screen or page as shown and indicated by reference 2270 and includes a “Consultation Required” window or popup 2282 configured with a “book consultation” button 2284. To continue with booking a consultation, the customer clicks or taps the “book consultation” button 2284. In response, the customer App is configured to refresh the Consultation Required page 2270 as indicated by reference 2272 with a “Choose consultation type” window or popup 2286 as shown in FIG. 22C. The Choose consultation type” window 2286 is configured with an “In-store” consultation select button 2287 and an “In-app” consultation button 2288 as shown. If the customer chooses an in-store consultation, the customer App is configured to execute the in-store consultation booking consultation 2200 as described above with reference to FIG. 22A. If, on the other hand, customer chooses an in-app consultation, the customer App is configured to execute the in-app consultation booking consultation 2240 as described above with reference to FIG. 22B.

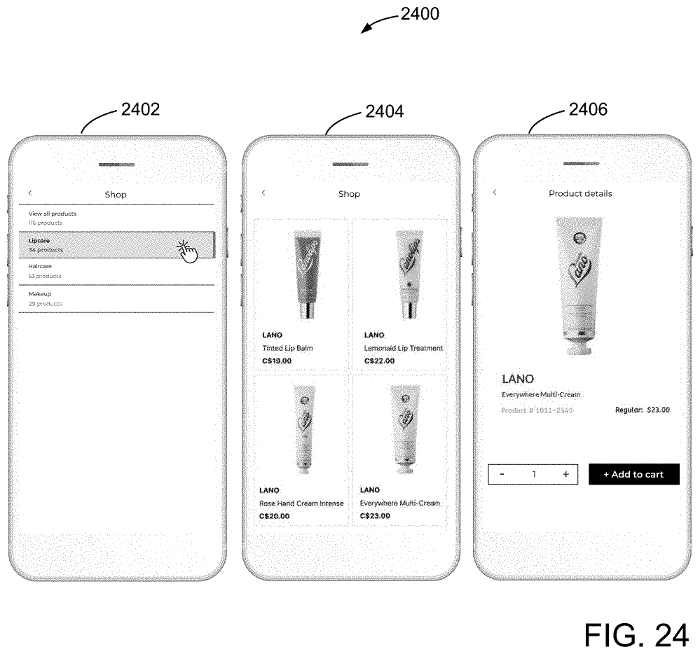

Reference is next made to FIG. 24, which shows a sequence of screenshots for a purchase a product process according to an embodiment and indicated generally by reference 2400. As shown, the customer App is configured to display a “Shop” page or screen 2402, which is configured to a list of product categories, in this example, “Skincare”, “Haircare”, “Lipcare” and “Makeup”. In response to the customer selecting, e.g. tapping, one of the product categories displays a product page 2404 corresponding to the selected product category, in this example, “Lipcare”. The product page 2404 is configured to display the individual products available for sale, and is further configured to be responsive to a customer input or gesture, e.g. a tap, and generate a “Product Details” page 2406 for the selected product, in this example, “LANO”. The Product Details page 2406 is configured to let the customer select the number of items or units to add to the cart, and continue with completing the purchase.

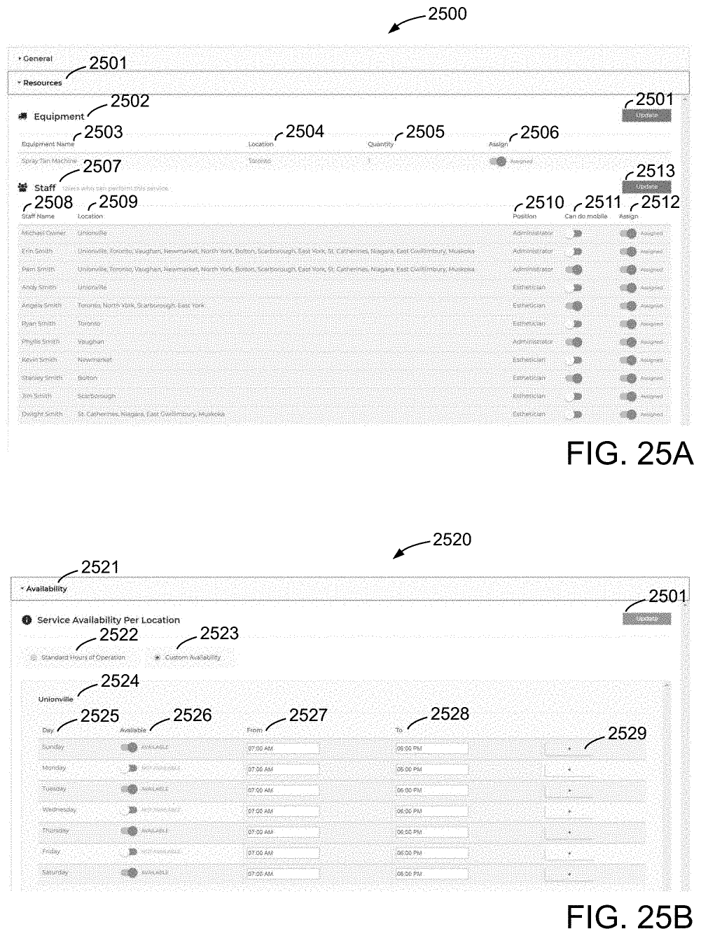

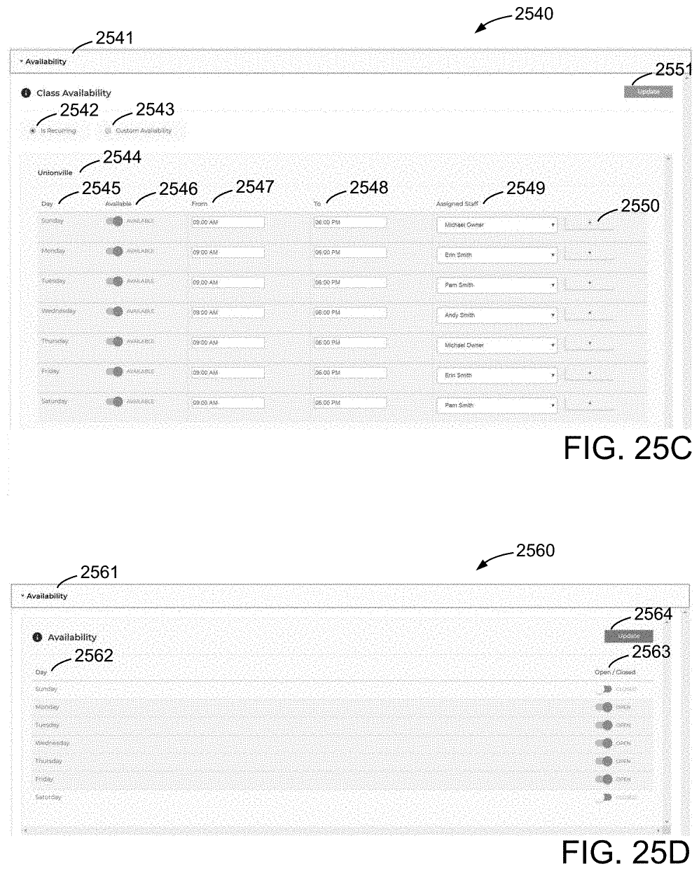

Reference is next made to FIG. 25A which shows a Resource Availability and Configuration page or screen as indicated by reference 2500. The Resource Availability and Configuration page 2500 is configured to allocate/deallocate resources for the business or enterprise. According to an exemplary embodiment, the resources 2501 comprise “Equipment” 2502 and “Staff” 2507. According to an exemplary implementation, the “Equipment” resources 2502 are configured according to “Equipment Name” 2503, “Location” 2504, “Quantity” 2505, “Assign” 2506 inputs, and the selected configuration is saved to memory by clicking or tapping an “Update” button 2514.

According to an exemplary embodiment, the Staff resources 2507 are configured according to “Staff Name” 2508, “Location” 2509, “Position” 2510, “Can do Mobile” input 2511 and “Assign” 2512 inputs or controls. The Staff resources are configured by a user utilizing the inputs to, for example, assign one or more staff members to the service along with ability to perform the service via mobile. The selected configuration is saved to memory by clicking or tapping an “Update” button 2513.

Reference is next made to FIG. 25B which shows a Service Availability screen or page indicated generally by reference 2520. The Service Availability page 2520 is configured for a user to set the availability of services on a per location basis. According to an exemplary embodiment, the service availability are defined or configured using a “Standard Hours of Operation” input 2522 or a “Custom Availability” input 2523 as primary selections. In response to a “Custom Availability” 2523 being selected, the system is configured to generate and display a list of Locations as indicated by reference 2524. As shown, the Service Availability page 2520 is configured to allow the user to configure the service availability utilizing a “Day(s)” selection input 2525, and an “Available” setting button 2526. When the “Available” setting is activated, the system is configured to activate a “From” input field 2527, a “To” input field 2528 and “+” or add button 2529. The “+” button 2529 is configured to allow the user to add additional times to the selected day. Once the service availability is fully configured, the configuration or changes are saved to memory using an “Update” button 2530.

Reference is next made to FIG. 25C, which shows a screenshot of a Class Availability screen or page according to an embodiment of the present invention and indicated generally by reference 2540. The Class Availability screen 2540 allows a user or administrator to configure a schedule of classes/staff available from or being offered by the business or enterprise. According to an exemplary implementation, the Class Availability screen 2540 provides the capability to configure classes as recurring, “Is Recurring” input 2542, or having a customizable availability, “Custom Availability” input 2543. In response to the “Is Recurring” input 2542 being selected, the system generates a list of Locations 2544, for example, “Unionville” 2544a and “Toronto” as shown in FIG. 25C. For each Location, the system is configured to provide the user with the following input controls/selections: “Day” input 2545 and “Available” input 2546. In response to the Available input 2546, the system is configured to activate or enable the following input controls/selections: “From” input 2547, “To” input 2548, “Assigned Staff” input 2549 and a “+” or add button 2550, which is configured to add additional times to be added to the day selected. If the “Custom Availability” 2543 option is selected by the user, the system is configured to prompt the user to enter in the “Date”, “From”, “To”, “Staff” for each location available. Once the class availability is configured by the user, the configuration is saved to memory using an “Update” button 2551.

Reference is next made to FIG. 25D, which shows a screenshot of a Package Availability screen or page according to an embodiment of the present invention and indicated generally by reference 2560. The Package Availability screen 2560 is configured to allow a user or administrator to configure a schedule for availability, “Availability” 2561 of a “package” from the business or enterprise. According to an exemplary implementation, the Package Availability screen 2640 provides the capability to configure package availability based on day(s) of the week, “Day” input 2562 and “Open/Closed” input 2563. Once the package availability is configured by the user, the configuration is saved to memory using an “Update” button 2564.

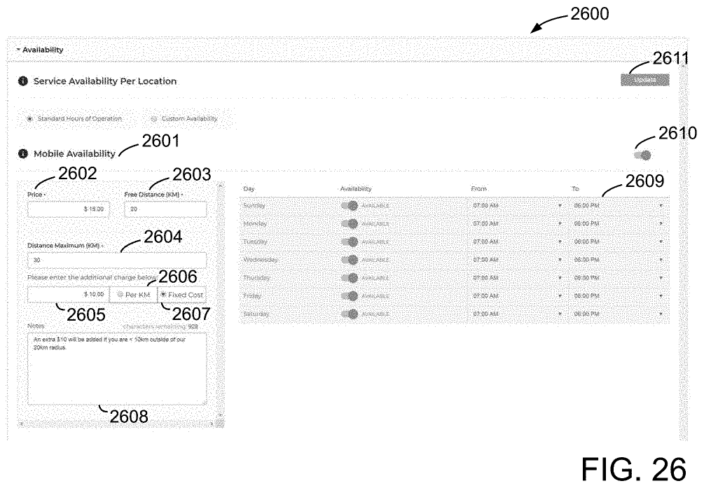

Reference is next made to FIG. 26, which shows a screenshot of a Mobile Service Availability and Configuration screen or page according to an embodiment of the invention and indicated by reference 2600. According to an exemplary implementation, the Mobile Service Availability screen 2600 comprises a “Mobile Availability” option 2601 which provides the capability to configure a service or class with mobile availability. The mobile availability for the service or class is enabled/disabled with an ON/OFF toggle button 2610. According to an exemplary implementation, the Mobile Service Availability and Configuration page 2600 includes the following inputs/controls for defining or configuring a mobile service: “Price” input 2602, “Free Distance (KM)” input 2603, “Distance Maximum (KM)” input 2604. According to another aspect, the Mobile Service Availability page 2600 includes the following inputs/controls for configuring optional parameters for the mobile service: “Additional Charge Amount” input 2605, “Per KM” or “Fixed Cost” inputs 2606 and 2607, “Notes” input 2608, “Custom Availability” input 2609, which provide a user or administrator with the ability to adjust the rules/conditions for when a mobile service can be requested and booked. Once the mobile availability of the service is configured by the user, the configuration is saved to memory using an “Update” button 2611.

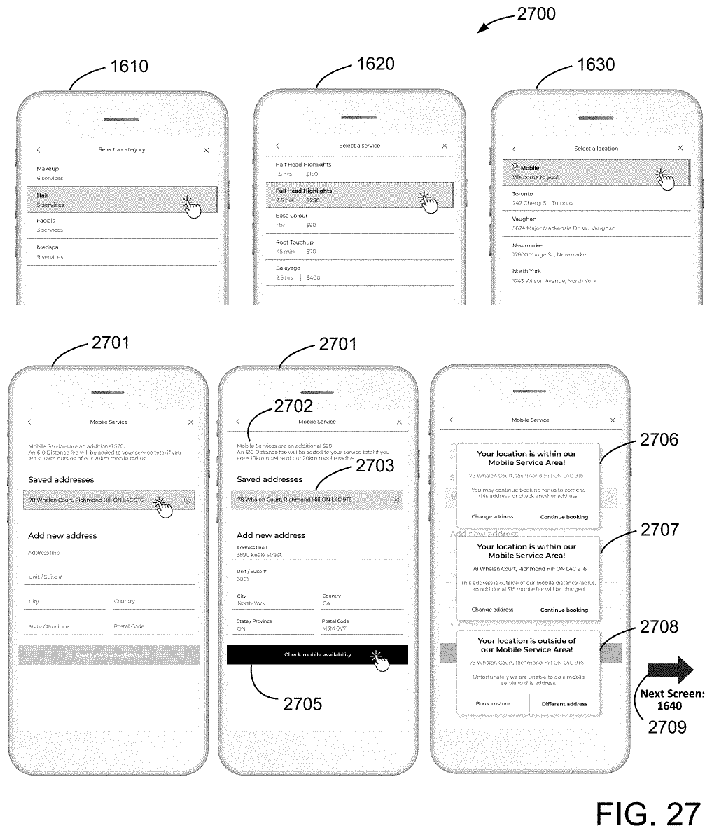

Reference is next made to FIG. 27, which shows a sequence of screenshots for a book a mobile appointment wizard according to an embodiment of the present invention and indicated generally by reference 2700. In response to a mobile appointment selection on the Locations List page 1630 (see also FIG. 16), the system generates and displays a Mobile Service screen or page 2701 as shown in FIG. 27. The Mobile Service screen 2701 is configured with a Notes field 2702 which outlines the input from the Notes input 2608 in the Mobile Service Availability screen 2600 (FIG. 26). The Mobile Service page 2701 also comprises a “Saved addresses” select button 2703, an “Add new address” input 2703, and a “Check mobile availability” button 2705. The Saved addresses button 2703 is configured to allow a user to select a saved address, for example, by clicking or tapping the Saved addresses button 2703. The Add new address button 2704 is configured to allow the user to enter a new address as shown in the screenshot 2701′. The availability of the mobile service at the saved address 2703 or the new entered address 2704 is determined by the system in response to the user clicking or tapping the “Check mobile availability” button 2705 (which is enabled in response to a saved address being selected or a new address being entered as indicated in the screenshot 2701′). According to an exemplary implementation, the app is configured to generate three options for the user (which are dependent on the service configuration, for example, in FIG. 26): “Your location is within our Mobile Service area” 2706; “Your location is within our Mobile Service area” but with an additional charge 2707; and “Your location is outside our Mobile Service area” 2708. In response to the user selecting one of the options 2706, 2707 or 2708, the app is configured to generate the booking page 1640 (FIG. 16) as indicated by reference 2709.

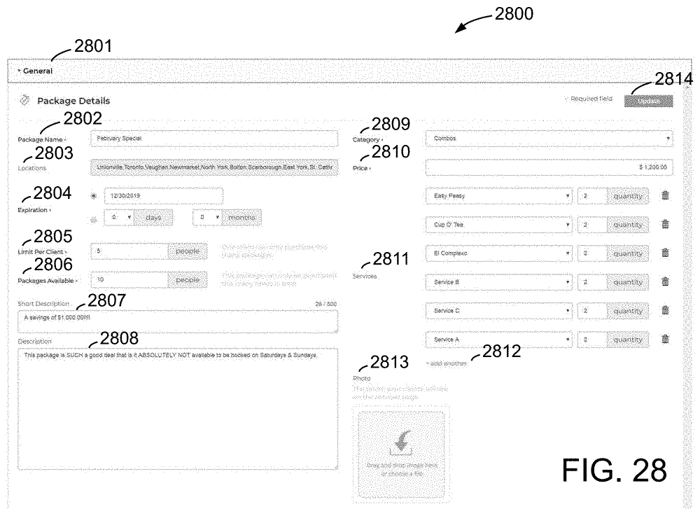

Reference is next made to FIG. 28, which shows a screenshot of a Package Configuration screen or page 2800 according to an embodiment of the present invention. The Package Configuration screen 2800 provides the capability for a user to configure the details/particulars associated with or offered in a package or for a class. According to an exemplary implementation, the Package Configuration 2800 comprises: a “Package Name” input 2802, a “Locations” selection input 2803, an “Expiration” input button 2804, a “Limit Per Client” input 2805, a “Packages Available” input 2806, a “Category” input 2809, a “Price” input 2810, a “Services” input 2811 (comprising quantity) and an “add another” service input 2812. According to a further exemplary implementation, the Package Configuration service page 2800 comprises optional parameter or definition input fields or settings: a “Short Description” input text box 2807, a “Description” input text box 2808, and a “Photo” input 2813. Once the package configuration for the service or class is configured by the user, the configuration is saved to memory using an “Update” button 2814.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A mobile communication device configured for executing an application program for providing a user with a plurality of channels for interacting with a business enterprise, said mobile communication device comprising:
a device display configured for displaying a plurality of screens generated by a processor executing the application program;
each of said plurality of screens comprising one or more user responsive inputs;
each of the plurality of channels comprising one or more of said plurality of screens, and said one or more user responsive input comprising context dependent functions for said associated channel; and
the plurality of channels comprising one or more of a service booking module, an ecommerce and payment module, a loyalty program module, an in-app consultation module, a client interaction module, a social media module and a marketing module.

2. The mobile communication device as claimed in claim 1, wherein said in-app consultation module comprises an in-app consult screen, said in-app consult screen comprising one or more photo inputs configured for each receiving a photo from the user, and said in-app consultation module further comprising an interface to a validation module configured for validating said one or more inputted photos, said validation module comprising an artificial intelligence module configured to execute an algorithm for validating said one or more inputted photos.

3. The mobile communication device as claimed in claim 2, wherein said in-app consultation module comprises a component configured to determine if said in-app consultation is a requirement, and if a requirement, said in-app consultation module being configured to display said in-app consult screen on said device display.

4. The mobile communication device as claimed in claim 1, wherein said service booking module comprises a chat component, said chat component being configured for providing an in-app communication channel between the user and another user associated with the business enterprise.

5. The mobile communication device as claimed in claim 1, wherein said client interaction module comprises a pre-appointment digital forms component, said pre-appointment digital forms component being configured for presenting one or more electronic forms on the device display prior to a booking of a service by the user, and said one or more electronic forms having a plurality of input fields responsive to user inputs for entering information on said one or more electronic forms, and said pre-appointment digital forms component includes a validation component configured to validate the entered information.

6. The mobile communication device as claimed in claim 1, wherein said client interaction module comprises a post-appointment digital forms component, said post-appointment digital forms component being configured for determining if a booking of a service requires aftercare and generating one or more electronic forms on the device display if aftercare is required, and said one or more electronic forms having a plurality of input fields responsive to user inputs for entering information on said one or more electronic forms, and said post-appointment digital forms component includes a validation component configured to validate the entered information.

7. A computer system for generating and configuring a customer application (app) associated with a business enterprise, said system comprising:
an end-user interface module, said end-user interface module being configured for providing access over the web for end-users comprising one or more consumer end-users and one or more business enterprise end-users;
a services module, said services module being configured for generating and configuring the app;
said services module being configured for generating a plurality of channels for the customer app for interacting with the business enterprise, and the plurality of channels comprising one or more of a service booking component, an ecommerce and payment module, a loyalty program module, an in-app consultation module, a client interaction module, a social media module and a marketing module
a database module, said database module being configured for storing data associated with the customer app and the business enterprise.

8. The computer system as claimed in claim 7, wherein said services module is configured to generate a business application (app) for the business enterprise, said business app being configured to interface with the customer application.

9. The computer system as claimed in claim 8, further comprising a mobile end-user interface module, said mobile end-user interface module being configured for interfacing said customer app and said business app.

10. The computer system as claimed in claim 10, wherein said services module comprises a chat module, said chat module being configured to provide an in-app chat facility for establishing a chat between the user of the customer app on a mobile device and an administrative user on the business app.

11. The computer system as claimed in claim 7, wherein said services module further comprises a create packages component configured to create a service package with a plurality of attributes defined by an administrator associated with the business enterprise, said plurality of attributes comprising one or more of availability, price, expiry and purchase availability.

12. The computer system as claimed in claim 7, wherein said services module further comprises a follow-up services component configured to create one or more follow-up actions for a service, said one or follow-up actions being defined by an administrator associated with the business enterprise and comprising one or more of a re-fill, a time-frame for follow-up and pre-requisite for follow-up.

13. The computer system as claimed in claim 7, wherein said loyalty program module is configured to create a loyalty points program available through the customer app, said loyalty point program comprising a plurality of loyalty program attributes defined by an administrator associated with the business enterprise, said plurality of loyalty program attributes comprising one or more of a number of points assignable to a service, a package of services, a number of points assignable to a referral to the business enterprise.

14. The computer system as claimed in claim 7, wherein said ecommerce and payment component is configured to establish a transaction payment channel with customer app executing on a mobile device, said ecommerce component comprising a plurality of policies configured by an administrator associated with the business enterprise, said plurality of policies comprising one or more of a deposit requirement for the service and a cancellation policy.

15. The computer system as claimed in claim 7, wherein said marketing module is configured for creating marketing promotions as defined by an administrator associated with the business enterprise, and said marketing module is further configured to push said marketing promotions to the customer app.

16. A computer program product comprising an application program for providing a user with a plurality of channels for interacting with a business enterprise, said computer program product being stored on a tangible machine readable medium, and comprising computer readable instructions for:
generating a plurality of screens for display on a device;
generating one or more user responsive inputs for each of said a plurality of screens;
each of the plurality of channels comprising one or more of said plurality of screens, and said one or more user responsive inputs comprising context dependent functions for said associated channel;
the plurality of channels comprising one or more of a service booking function, an ecommerce and payment function, a loyalty program function, an in-app consultation function, a client interaction function, a social media function and a marketing function.

17. The computer program product as claimed in claim 16, wherein said in-app consultation comprises generating an in-app consult screen comprising one or more photo inputs configured for each receiving a photo from the user, and further including validating said one or more inputted photos utilizing an artificial intelligence module configured to execute an algorithm for validating said one or more inputted photos.

18. The computer program product as claimed in claim 17, further including determining if said in-app consultation is a requirement, and if a requirement, displaying said in-app consult screen on said device display.

19. The computer program product as claimed in claim 16, wherein said service booking function comprises generating a booking screen and said booking screen comprising an in-app chat function, and further comprising establishing a chat conversation with the customer for booking the service and an administrator associated with the business enterprise, and storing said service booking in a system memory.
